(19) United States
(12) Patent Application Publication
(10) Pub. No.: US 2008/0288286 A1
(43) Pub. Date: Nov. 20, 2008

(54) Systems and Methods of Analyzing Healthcare Data

(75) Inventors: Rebecca Noreen, Eden Prairie, MN (US); Chad Peel, Chaska, MN (US)

Correspondence Address: FULBRIGHT & JAWORSKI L.L.P., 600 CONGRESS AVE., SUITE 2400, AUSTIN, TX, 78701, US

(73) Assignee: United HealthCare Services, Inc.

(21) Appl. No.: 12/122,386

(22) Filed: May 16, 2008

Related U.S. Application Data
(60) Provisional application No. 60/938,629, filed on May 17, 2007.

(51) Int. Cl. G06Q 50/00; G06Q 10/00

(52) U.S. Cl. 705/2

(57) ABSTRACT

The present invention provides systems and methods of analyzing healthcare data. In one embodiment, a Medical National Operations Center application (MNOC) displays clear, concise and actionable information, with visual indicators, to help Line of Service (LOS) teams to manage their operations by providing a dashboard of information. For example, the application may present selected summaries of data, baseline targets, customized metrics and interactive alerts that will be used to monitor, analyze and measure LOS performance. In one embodiment, the systems and methods of the present invention may be implemented in a health insurance provider system. As such, the present invention may provide access to additional, real-time data to evaluate initiatives allowing the LOS to react quickly to variances and expected results. Further, the present invention may provide tools to evaluate the effectiveness and performance of initiatives and programs, such as, for example, member steerage tools.

### CROSS-REFERENCE TO RELATED APPLICATION

This application claims priority to U.S. Provisional Patent Application No. 60/938,629, filed May 17, 2007, which is incorporated by reference herein without disclaimer.

### BACKGROUND OF THE INVENTION

1. Technical Field

The present invention relates generally to health insurance applications and, more particularly, to systems and methods of analyzing healthcare lines of service.

2. Description of Related Art

An example of a data warehousing infrastructure and service may be found in U.S. Pat. No. 7,191,183. Also, an example of a care management system which aggregates, integrates and stores clinical information from disparate sources may be found in U.S. Pat. No. 6,802,810.

### BRIEF SUMMARY OF THE INVENTION

Exemplary embodiments of the present invention provide systems and methods of analyzing healthcare data. In one embodiment, a Medical National Operations Center application (MNOC) displays clear, concise and actionable information, with visual indicators, to help Line of Service (LOS) teams and field operation teams to manage their operations by providing a dashboard of information. For example, the application may present selected summaries of data, baseline targets, customized metrics and interactive alerts that will be used to monitor, analyze and measure LOS programs and other operational areas performance. It may also include the capability to drill into the detail information to further analyze the data.

In one embodiment, the systems and methods of the present invention may be implemented in a health insurance provider system. As such, the present invention may provide access to additional, real-time data to evaluate initiatives allowing the LOS and field operational teams to react quickly to variances and expected results. As used herein, “real-time data” includes data that is available for review contemporaneously or nearly contemporaneously with an actual event. In certain exemplary embodiments, the data is available within one hour, while in other exemplary embodiments, the data is available within one day of the event. For example, in one exemplary embodiment, data relating to a patient's admission to a health care facility may be available for review as soon as the information is entered into a network information system.

Exemplary embodiments comprise a method of identifying and contacting a candidate for a disease management program. In specific embodiments, the method comprises reviewing data for admissions to a health care facility for a plurality of health care plan members; identifying a condition for the admissions of the plurality of health care plan members; identifying a disease management program addressing the condition; reviewing an enrollment status in the disease management program for the plurality of health care plan members; identifying a non-enrolled portion of the plurality of health care plan members that are not engaged in the disease management program; contacting a member the non-enrolled portion while the member of the non-enrolled portion is admitted to the health care facility or shortly thereafter; and requesting that the member of the non-enrolled portion become engaged with the disease management program. As used herein, the term “shortly thereafter” includes time periods of one day, one week or two weeks, or any time in between these exemplary limits.

In certain embodiments, the data for admissions to a health care facility for a plurality of health care plan members is displayed on a graphical user interface. In specific embodiments, the graphical user interface can be manipulated to display data relating to an individual health care plan member and/or to a particular geographic region. The graphical user interface may be manipulated to display data based on the type of contractual agreements between the health care facility and a manager of the health care plan, and/or manipulated to display data relating to an individual physician. Specific embodiments may also comprise categorizing the plurality of health care plan members into groups based on the amount of time since the health care plan member has been contacted regarding the disease management program. Other embodiments may comprise categorizing the plurality of health care plan members into groups based on the amount of time that the health care plan member has been admitted to the health care facility. In certain embodiments, the condition may be a cardiac condition, asthma, diabetes, an oncological condition, or a neo-natal condition.

In specific embodiments, the enrollment status comprises: members who have been identified but not contacted regarding the disease management program; members who have been contacted regarding the disease management program; members who are enrolled in the disease management program; members who are actively engaged in the disease management program; and members who are disenrolled in the disease management program.

Other embodiments may comprise a computer readable medium comprising a computer program recorded thereon that causes a computer to perform the steps of: providing a graphical user interface; displaying data for admissions to a health care facility for a plurality of health care plan members; identifying a condition for the admissions of the plurality of health care plan members; identifying a disease management program addressing the condition; displaying an enrollment status in the disease management program for the plurality of health care plan members; and identifying a non-enrolled portion of the plurality of health care plan members that are not engaged in the disease management program. In certain embodiments, the graphical user interface can be manipulated to display data relating to an individual health care plan member, and/or relating to a particular geographic region. The graphical user interface may also be manipulated to display data based on the type of contractual agreements between the health care facility and a manager of the health care plan, and/or manipulated to display data relating to an individual physician. In certain embodiments, the graphical user interface may be configured to categorize the plurality of health care plan members into groups based on the amount of time since the health care plan member has been contacted regarding the disease management program.

Embodiments may also comprise a method of evaluating data for utilization rates for health care providers (e.g. physicians, nurses, or health care facilities). In specific embodiments, the method comprises: obtaining data for utilization rates for a plurality of health care providers; determining a normal range of utilization; identifying a subset of the health care providers with utilization rates that are within the normal range of utilization; and identifying a subset of the health care providers with utilization rates that are outside of the normal range of utilization. Certain embodiments may also comprise: contacting a health care provider that is in the subset of the health care providers with utilization rates that are outside of the normal range of utilization and notifying the health care provider of the normal range of utilization and the utilization rate for the health care providers. Specific embodiments may also comprise directing members of a health care plan to receive treatment from health care providers that are within the subset of the health care providers with utilization rates that are within the normal range of utilization. The utilization rate may comprise a ratio of a cardiac procedure per number of office visits, and in particular embodiments, the utilization cardiac procedure is chosen from the list consisting of: an angiogram, a perfusion, an echocardiogram, an EKG, a stress test, a cardiac computed tomography, and a cardiac magnetic resonance imaging. Certain embodiments may also comprise categorizing the data for utilization rates for a plurality of health care providers by geographic region. Specific embodiments may also comprise categorizing the data for utilization rates for a plurality of health care providers by the quality and efficiency of the health care providers.

Other embodiments may include a computer readable medium comprising a computer program recorded thereon that causes a computer to perform the steps of: providing a graphical user interface; displaying data for utilization rates for a procedure for a plurality of health care providers; displaying a normal range of utilization; and identifying a subset of the health care providers with utilization rates that are outside of the normal range of utilization. In specific embodiments, the utilization rates are categorized based on the quality and efficiency of the health care provider. The utilization rate may comprise a ratio of a cardiac procedure per number of office visits. In certain embodiments, the cardiac procedure is chosen from the list consisting of: an angiogram, a perfusion, an echocardiogram, an EKG, a stress test, a cardiac computed tomography, and a cardiac magnetic resonance imaging.

In certain embodiments, the graphical user interface can be manipulated to display data for utilization rates for a plurality of health care providers categorized by geographic region. In specific embodiments, the graphical user interface can be manipulated to display data for utilization rates for a plurality of health care providers categorized by the quality and efficiency of the health care provider.

Embodiments may also comprise a method of identifying an opportunity for an improvement in a health care plan member's quality of health coupled with a medical cost reduction. In certain embodiments, the method may comprise reviewing real-time data for admissions to a health care facility for a plurality of members of a health care plan of a client; identifying a subset of the plurality of members of the health care plan, wherein members of the subset were admitted to the health care facility with one or more conditions; identifying a disease management program addressing the one or more conditions, wherein the disease management program is not currently purchased by the client; notifying the client of the subset of the plurality of members of the health care plan that were admitted to the health care facility with the one or more conditions; and notifying the client of availability of the disease management program. In specific embodiments, the disease management program is configured to address a coronary artery disease, heart failure, diabetes, asthma, chronic obstructive pulmonary disease, or low back pain.

Further, embodiments of the present invention may reduce the number of ad hoc queries and reports through other systems and may enable the business users to easily access key data. As such, the present invention may provide tools to evaluate the effectiveness and performance of initiatives and programs including member steerage programs (e.g., “hard” steerage—financial incentives—and/or “soft” steerage—suggestions).

The foregoing has outlined rather broadly certain features and technical advantages of the present invention so that the detailed description that follows may be better understood. Additional features and advantages are described hereinafter. As a person of ordinary skill in the art will readily recognize in light of this disclosure, specific embodiments disclosed herein may be utilized as a basis for modifying or designing other structures for carrying out the same purposes of the present invention. Such equivalent constructions do not depart from the spirit and scope of the invention as set forth in the appended claims. Several inventive features described herein will be better understood from the following description when considered in connection with the accompanying figures. It is to be expressly understood, however, the figures are provided for the purpose of illustration and description only, and are not intended to limit the present invention.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1. shows an access frequency and data detail diagram according to an exemplary embodiment of the present invention.

FIG. 2A shows a selection of filters that can be selected to display data according to an exemplary embodiment of the present invention.

FIG. 2B shows a chart displaying data related to the length of stay in a healthcare facility according to an exemplary embodiment of the present invention.

FIG. 3 shows a chart displaying data related to enrollment status according to an exemplary embodiment of the present invention.

FIG. 4 shows a chart displaying data related cardiac admissions by enrollment status according to an exemplary embodiment of the present invention.

FIG. 5 shows a chart displaying data related to the number of days since last contact according to an exemplary embodiment of the present invention.

FIG. 6 shows a chart displaying data related to the number of open care defects by month according to an exemplary embodiment of the present invention.

FIG. 7 shows a chart displaying data related to the number cardiac admissions by day according to an exemplary embodiment of the present invention.

FIG. 8 shows a chart displaying data related to hospitals by contract type according to an exemplary embodiment of the present invention.

FIG. 9 shows a chart displaying data related to the amount of money spent by health care facilities by designation, according to an exemplary embodiment of the present invention.

FIG. 10 shows a chart displaying data related to the number of cardiac implants, according to an exemplary embodiment of the present invention.

FIG. 11 shows a chart displaying data related to the number of cardiologist procedures by designation, according to an exemplary embodiment of the present invention.

FIG. 12 shows a chart displaying data related to the number of angiograms per cardiology office visit, according to an exemplary embodiment of the present invention.

FIG. 13 shows a chart displaying data related to the rate of perfusion studies to total members, according to an exemplary embodiment of the present invention.

FIG. 14 shows a chart displaying data related to the percent utilization of oncology drugs by therapy class, according to an exemplary embodiment of the present invention.

FIG. 15 shows a chart displaying data related to the percentage of unlisted drug claim submissions, according to an exemplary embodiment of the present invention.

FIG. 16 shows a chart displaying data related to EPO claims, according to an exemplary embodiment of the present invention.

FIG. 17 shows a chart displaying data related to Herceptin claims, according to an exemplary embodiment of the present invention.

FIG. 18 shows a chart displaying data related to the number of physicians on the proprietary fee schedule, according to an exemplary embodiment of the present invention.

FIG. 19 shows a chart displaying data related to the number of members in the cancer support program, according to an exemplary embodiment of the present invention.

FIG. 20 shows a chart displaying data related to the distribution of case management assessments, according to an exemplary embodiment of the present invention.

FIG. 21 shows a chart displaying data related to the complications of chemotherapy assessments, according to an exemplary embodiment of the present invention.

FIG. 22 shows a chart displaying data related to the percentage of engaged patients with various stages of cancer, according to an exemplary embodiment of the present invention.

FIG. 23 shows a chart displaying data related to the percentage of patients utilizing hospice, according to an exemplary embodiment of the present invention.

FIG. 24 shows a chart displaying data related to the engaged case distribution, according to an exemplary embodiment of the present invention.

FIG. 25 shows a chart displaying data related to the average number of hospital days per cancer patient, according to an exemplary embodiment of the present invention.

FIG. 26 shows a chart displaying data related to premium designated physicians, according to an exemplary embodiment of the present invention.

FIG. 27 shows a chart displaying data related to premium designated specialty centers, according to an exemplary embodiment of the present invention.

FIG. 28 shows an MNOC system architecture, according to an exemplary embodiment of the present invention.

FIG. 29 shows illustrates computer system (including mobile technology) adapted to use embodiments of the present invention.

### DETAILED DESCRIPTION OF THE INVENTION

In the following description, reference is made to the accompanying drawings which illustrate exemplary embodiments of the invention. These embodiments are described in sufficient detail to enable a person of ordinary skill in the art to practice the invention, and it is to be understood that other embodiments may be utilized, and that changes may be made, without departing from the spirit of the present invention. The following description is, therefore, not to be taken in a limited sense, and the scope of the present invention is defined only by the appended claims.

Certain embodiments of the present invention provide a Medical National Operations Center (MNOC) application that displays clear, concise and actionable information, with visual indicators, that helps the Line of Service (LOS) teams and field operations to manage their operations. As used herein, the term “Line of Service” comprises categories of conditions that relate to various types of services including inpatient, outpatient, and ancillary services. Examples of Lines of Service include, for example, cardiology, oncology, women's health, and Neuro Ortho Spine, and field operations among many others. The MNOC application may allow others within a healthcare organization to integrate it into their operations management. In one embodiment, MNOC may be accessible to a plurality of business. Furthermore, the application may be customized to incorporate additional or alternative Lines of Service as desired.

In one embodiment, a MNOC application provides a reporting system that allows a health or medical insurance carrier to determine how well the business is performing relative to expectations, which specific areas of the business require immediate action, whether certain data points are outside of control parameters, the detail behind the chart-based information, and/or opportunities to improve the quality of data. As such, the MNOC application may provide a window or dashboard into the Lines of Service organizations, both individually and collectively. The MNOC application may include, for example, selected summaries of data, baseline targets, customized metrics and interactive alerts that will be used to monitor, analyze and measure LOS and other medical areas of focus performance (including for example, Inpatient and Disease Management Programs). It may also include the capability to drill into the detailed information to further analyze the data.

Exemplary embodiments also comprise a method of identifying and contacting a candidate for a disease management program (and/or a computer readable comprising a computer program recorded thereon that assists a user in performing the method). In specific embodiments, a user may utilize a graphical user interface to review data for admissions to a health care facility for health care plan members. The program can identify a condition for the admissions of the health care plan members, as well as identify a disease management program that addresses the condition. The program can also review whether or not the health care plan members are already enrolled in the disease management program.

After the program identifies members that are not enrolled in the disease management program, the user may contact a non-enrolled member while the member is admitted to the health care facility or shortly thereafter; and invite the member to enroll and engage with the disease management program. Contacting the non-enrolled member while he or she is still in the health care facility or shortly thereafter release increases the likelihood that the member will enroll in the disease management program by up to forty percent.

Other exemplary embodiments provide a user with potential opportunities to present to a client, utilizing the client's specific membership, a potential improvement in a health care plan member's quality of health coupled with a medical cost reduction. These achievements may be realized by reviewing real-time data for admissions to a health care facility for members of a health care plan of a client and identifying members who were admitted with one or more conditions that could be addressed by a disease management program that is not currently purchased by the client. The user can then notify the client of the number of members of the health care plan that were admitted to the health care facility with the conditions and notifying the client of availability of the disease management program addressing those conditions. By bringing the availability of the disease management program to the client's attention, the client may choose to purchase the program and thereby improve the quality of health for the plan members and reduce medical costs for both the plan members and the client.

In exemplary embodiments, Disease Management Programs are designed to empower individuals to best manage their chronic diseases and related conditions, improve adherence to evidence-based medicine treatment plans and medication regimens, reduce unnecessary emergency room visits, hospitalizations and related health care costs, and ultimately improve quality of life. Specific, non-limiting examples of Disease Management Programs include Coronary Artery Disease (CAD), Heart Failure, Diabetes, Asthma, Chronic Obstructive Pulmonary Disease (COPD), and Low Back Pain. Disease Management Programs are designed to target the elements that support the best clinical and financial outcomes: the right health care provider, the right medications, the right care and the right lifestyle. Individuals may be identified for program participation via a range of methods including health assessments, program referrals, notifications, predictive modeling and claims data.

A program manager may then assess the needs of the whole person, and their acuity level, potential for impact, readiness to change, and health values and preferences. Nurses can work with the individual to develop a personal care plan and transfer skills and knowledge to help them best manage their condition. In addition to condition-specific interventions, Disease Management Programs support individuals in maintaining a healthy lifestyle and adhering to physician treatment plans and medication regimens, effectively managing their condition and co-morbidities (including depression), and receiving the most clinically-appropriate, cost-effective and timely diagnostic testing and procedures. The program manager can provide a robust reporting package that includes in-depth clinical data on the individuals managed. The manager may also track the specific areas and activities of clinical interventions. Customized reports are also available based on specific needs.

Specific details of exemplary embodiments of Disease Management Programs are provided below. Some of the goals of the CAD program are to help individuals best manage their condition and risk factors, and prevent heart attacks and unnecessary hospitalizations. The CAD program provides information and resources individuals need to understand their condition and its implications, and how to reduce or eliminate risk factors such as high cholesterol, high blood pressure, diabetes, excess weight, obesity, cigarette smoking, and lack of physical activity. Some of the goals of the Heart Failure program are to help individuals prevent heart failure exacerbations, and recognize changes in symptoms and actively intervene to reduce unnecessary hospitalizations. The Heart Failure program provides information and resources individuals need to understand their condition and its implications, and recognize and manage their symptoms. The program can also help individuals to improve physical activity tolerance, reduce or eliminate health risk factors such as high cholesterol, excess weight, obesity and smoking.

Some of the goals of the Diabetes program are to help individuals best manage their condition, blood glucose levels and risk factors, reduce unnecessary emergency room visits, and prevent disease progression and other illnesses related to poorly managed diabetes. The Diabetes program provides information and resources individuals need to understand their condition and its implications, and how to reduce or eliminate risk factors such as high cholesterol, high blood pressure, excess weight, obesity, smoking, and lack of physical activity.

Some of the goals of the Asthma program are to help individuals best manage their condition, avoid triggers for asthma attacks, reduce unnecessary emergency room visits and hospitalizations, and improve their quality of life. The Asthma program provides information and resources individuals need to understand their condition and its implications, and how to avoid triggers that induce or aggravate asthma attacks (such as exposure to environmental allergens and irritants) and reduce or eliminate risk factors such as smoking.

Some of the goals of the COPD program are to help individuals avert acute episodes, reduce unnecessary hospitalizations, and live as comfortably as possible with this advanced stage of respiratory illness. The COPD program provides information and resources individuals need to understand their condition and its implications, and how to avoid triggers that induce or aggravate respiratory episodes (such as exposure to environmental allergens and irritants) and reduce or eliminate health risk factors such as smoking.

The Healthy Back program is uniquely positioned to deliver savings and quality of life improvement by empowering individuals with information to make low back care decisions that are evidence-based, removing lifestyle barriers and enhancing individuals' skills for self-care and self-management of low back conditions, and improving individuals' care seeking patterns towards high quality and efficient providers.

In another embodiment, a MNOC application will provide access to additional, real-time data to evaluate initiatives allowing the LOS to react quickly to variances and expected results. MNOC may advantageously reduce the number of ad hoc queries and reports through other systems. These capabilities enable the business users to easily access key data. Moreover, MNOC provides the tools for evaluating the effectiveness and performance of initiatives and programs.

For example, a MNOC application in accordance with certain aspects of the present invention may provide significant value by accessing more real-time, and upstream data—connected across key variables (e.g., patients active in a Disease Management program that are non-compliant with Rx and that have recently been to the emergency room). This smarter data results in more actionable, timely interventions by LOS management, field operations and partners (including for example, physicians, hospitals, group practices, ancillaries, skilled nursing facilities, pharmacies, or any other individual or group of individuals that provide health care services). In one embodiment, real-time data is received as associated with each member, provider, facility, physician or other entity, for example by the use of magnetic cards, personal identification numbers, biometric readers, or the like.

One of the many benefits provided by embodiments of the present invention is that they allows time to be spent focusing on clear priorities, not the day to day challenges regarding reporting, responding to inquiries, etc. The focus of daily efforts transitions from questions about “what” to inquiries into “why;” thus empowering others to take more actionable, immediate measures based on data. Consequently, a MNOC application positions the LOS organizations to more effectively manage their business by better informing the groups and enable them to achieve their overall objectives.

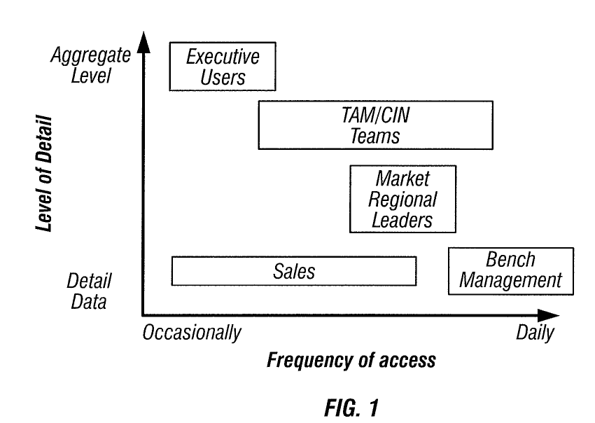

FIG. 1 depicts an access frequency and data detail diagram with respect to several user types. It summarizes how frequently they access the MNOC application and what level of detail they require. Access privileges may be associated with each user and/or each type of user in the form of user profiles. In this manner, users are required to provide proper authorization, including clearance and market assignments, to view charts.

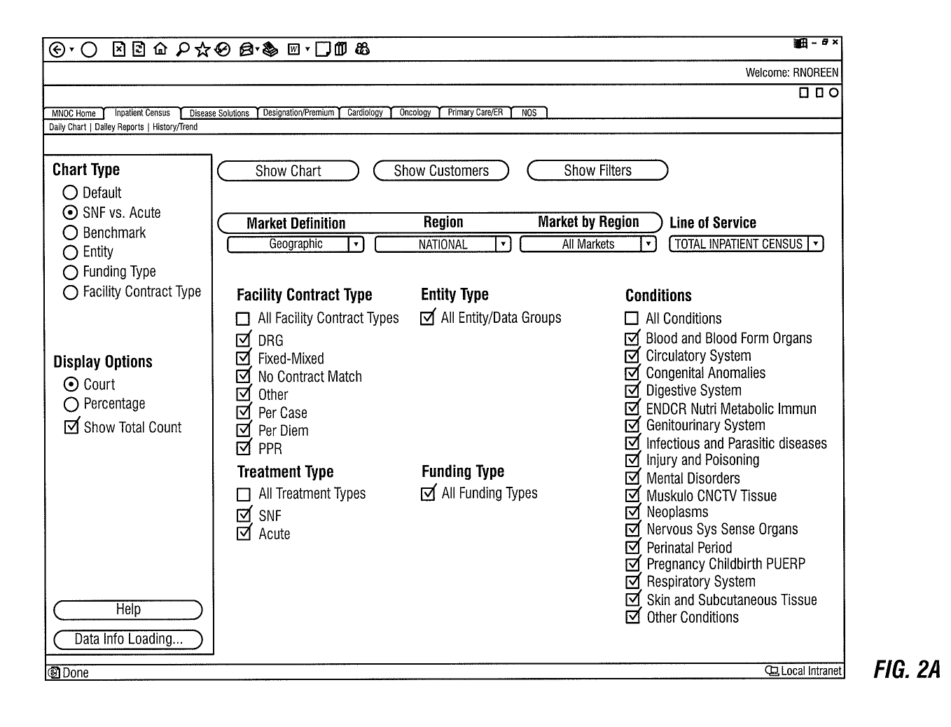

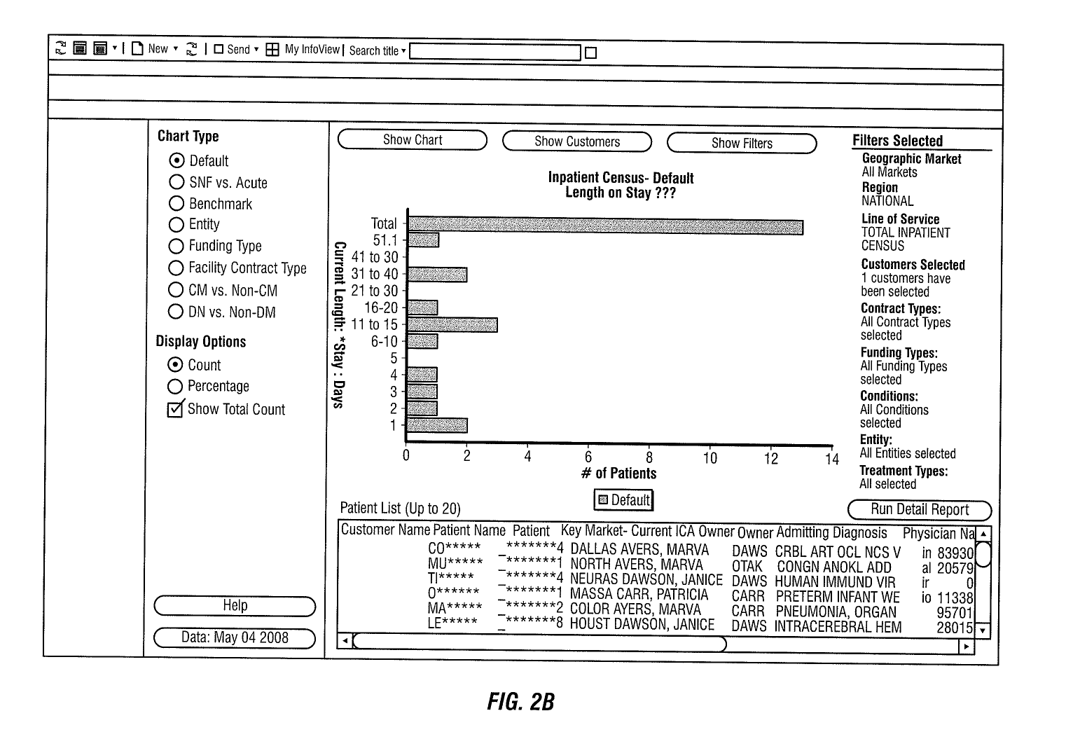

FIGS. 2A and 2B show a examples of a display of a graphical user interface of a MNOC application. The MNOC application may be provide enterprise-capable executive dashboard functionality, access to various source data, support for dynamic drilldown detail reporting, and support for zero footprint web browser. As shown in FIG. 2, dynamic drilldown detail reporting may include a list of patients, doctors, procedures, etc. In one embodiment, the MNOC application is presented in an easy to understand and to use graphical user interface (GUI) with the executive user in mind.

As noted above, the MNOC application may be deployed via a web-client with zero footprints—i.e., no client-side software installment is required or necessary. This alleviates the burden of a national deployment and allows additional users to rapidly gain access to the application. Furthermore, users may have the ability to see many predefined views of charts and drilldowns based on their organizational access. Additionally, some of the users may be able to modify one or more of the graphs to perform ad hoc analysis. Upon login to the MNOC, the user is presented with a main dashboard consisting of links to the user's available charts. This is a central control panel that is used to navigate through the charts categorized by different lines of service or by the chart types (i.e. inpatient, disease management, network management, physician utilization, etc). This main dashboard may also display alerts specific to the user.

FIGS. 2A and 2B depict, respectively, a filter selection and a chart entitled “Inpatient Census—Default”, which shows the total number of patients residing in a hospital and their current length of stay. In certain embodiments, this chart allows a user to ensure quality of care for members through identification of disease management alignment and enrollment in programs for conditions that lead to the member's hospitalization. In specific embodiments, the chart is updated daily, but in other embodiments, it may be updated at different intervals.

The chart can also allow a user to ensure that a member's care is consistent for the member's condition and to minimize variation by facility. For example, the data can allow a user to benchmark a length of stay to ensure that a facility does not detain a member for a contractual revenue benefit. In one example, the data can be used to ensure a facility does not release a member too early if the facility is on a condition flat payment arrangement or keep a patient longer than needed due to a per diem pay arrangement. In certain embodiments, the chart allows the user the ability to filter on region and market or contract type. In the specific embodiment shown, the chart displays the number of patients that have been in the hospital or care facility for 1 day, 2 days, 3 days, 4 days, 5 days, 6-10 days, 11-15 days, 16-20 days, 21-30 days, 31-40 days, 41-50 days, 51+ days, and the total number of patients.

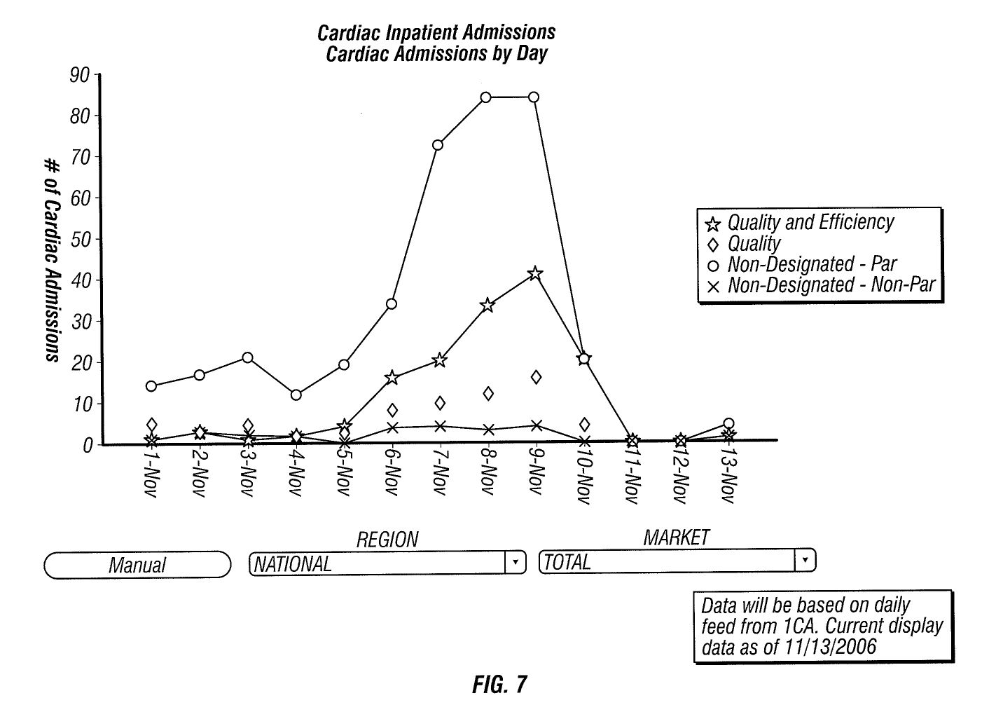

The chart may also provide a user the ability to toggle between all patients and patients enrolled in a Disease Management program, and to benchmark a LOS for condition, acuity level, or condition type, etc. The user may also be able to toggle by contract type (determined by facility), as well as have the ability to see data for each LOS patients only. As shown in FIG. 7A, a user may have the ability via n optional filter to view data by customer/policy, market/region, condition, product type (fully insured, ASO, Medicare, Medicaid, etc). A user can review more specific data by reviewing a list of patients with the corresponding length of stay and region/market filter. The chart also provide a user the ability to group and summarize by any of these fields: Patient Key (masked except last four digits); Patient First Name; Current Inpatient; Care Advocate Owner; Permanent Inpatient Care Advocate Owner; Diagnosis; Service; Physician Name; Physician MPIN/TIN; Physician Designation (quality, quality & efficiency, non designated, insufficient volume for designation); Facility; Facility Contract Type; and/or Facility Designation (quality, quality & efficiency, non designated, insufficient volume for designation). Example alerts can be triggered if the number of patients with length of stay is greater than a certain period of time (e.g., 11-20 days or greater than 21 days) exceeds a certain threshold. In specific embodiments, the alerts can be adjusted to account for the type of contract and for the target length of stay for a specific condition.

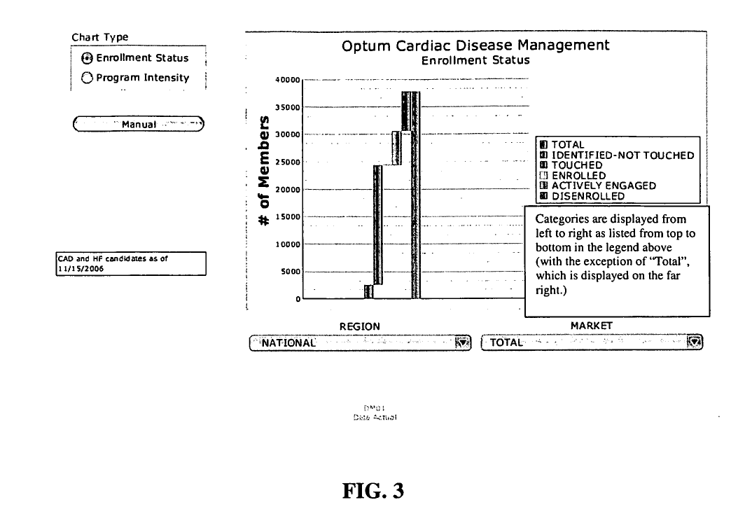

Referring now to FIGS. 3-29, various charts according to exemplary embodiments of the present invention are depicted. These charts may present a large amount of information graphically, allowing the user to identify trends and outliers. The tables that follow explain the content of each chart, in which a chart number is used to identify the chart, a chart title name is used to identify the chart, a chart description provides a brief description of the chart, a chart type describes the type of chart (e.g., line, bar, stacked bar, horizontal column, etc.), groups accessing describe the primary users of the chart, update frequency shows how often the data is refreshed, chart requirements list of all functionality available in this chart, including filtering existing data, toggling different criteria, etc., drilldown requirements show what child charts are connected to the chart, chart metrics describes the business purpose of tracking this information, and exemplary soft and hard alerts.

Referring now to FIG. 3, a chart entitled “Disease Management Patients by Enrollment Status/Severity Level” depicts the total number of disease management patients in each enrollment status or program level. This chart provides visual as well as support detail with the click of button. The chart can provide a measure of program engagement levels with the identified population. In certain embodiments, the chart may be updated weekly or daily. In certain embodiments, a user has the ability to filter on a region and market as defined by patient or provider. The user may also be able to toggle between “Enrollment Status” and “Program Intensity.” In an exemplary embodiment, categories for “Enrollment Status” consist of (in the following order): Identified-Not Touched (e.g., identified but not contacted regarding the program); Touched; Enrolled; Actively Engaged; Disenrolled—Opted Out; Disenrolled—Success. “Program Intensity” may consist of the following categories (in the following order): Low Mailings; Moderate Mailings; Moderate Contact; High Contact. The user can have the ability to filter on the type of insurance (for example, fully insured, self insured, Medicare, Medicaid, etc.) and the ability to toggle between the insurance or product type. The chart can also provide the user the ability to access the description of each “Enrollment Status” and “Program Intensity” on demand, and the ability to toggle between total or percent or each category.

In certain embodiments, a user may have the ability to examine data for specific patients and their status within the disease management program. In specific embodiments, a user may have the ability to examine any bar to see a 6 month trend of that bar, to toggle between percentage or total, and to view the patient's duration in a status. The chart may also be used to display the total number or percent of patients moving from one status to another. Alerts can be set if the number of members categorized as “Identified” increases by a certain number or percentage, or if the number of members categorized as “Disenrolled—Success” decreases by a certain number or percentage. Similarly, alerts can be set if the number of members categorized as “Disenrolled—Opted Out” increases by a certain number or percentage or the number of members categorized as “Actively Engaged” increases by a certain number or percentage.

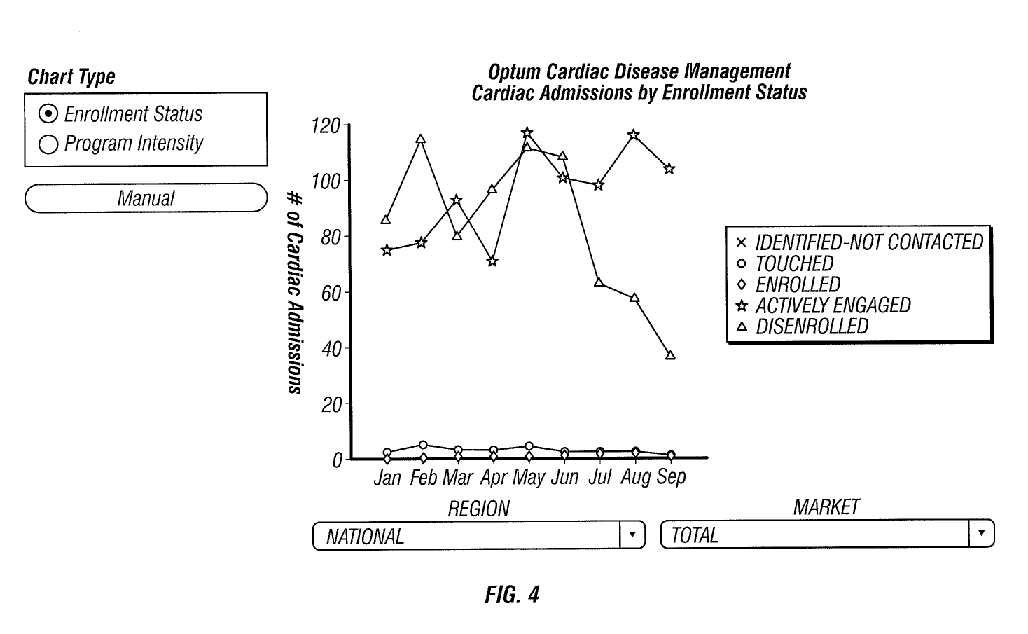

Referring now to FIG. 4, a chart entitled “Admissions by Enrollment Status/Severity Level (by LOS)” shows Line of Service (LOS) admissions by month, along with the patient's disease management enrollment status or severity level at the time of admission. This chart indicates the level of success for helping members manage their disease and minimize escalated health situations (for example, hospitalization). In certain embodiments, this chart may be updated monthly or weekly. The chart can have the ability to filter on a region and market and the ability to toggle between “Enrollment Status” and “Intensity Level.” In an exemplary embodiment, categories for “Enrollment Status” consist of (in the following order): Identified-Not Touched; Touched; Enrolled; Actively Engaged; Disenrolled—Opted Out; Disenrolled—Success. “Program Intensity” may consist of the following categories (in the following order): Low Mailings; Moderate Mailings; Moderate Contact; High Contact. The user can have the ability to filter on the type of insurance (for example, fully insured, self insured, Medicare, Medicaid, etc.) and the ability to toggle between disease management programs.

In certain embodiments, the user can have the ability to access a description of each “Enrollment Status” and “Program Intensity” on demand. The user may also have the ability to view data by time periods of a week, month, 3 months, 6 months, or 12 months and/or to view data as a total number or percentage. In certain embodiments, a user may have the ability to examine data for specific patients, including patient identification number, name, disease management nurse, number of open Right Care gaps (e.g. follow evidence based medicine), number of open Right Lifestyle gaps (e.g. smoking cessation, weight, exercise), number of open Right Provider gaps (e.g. high quality physicians for condition), and/or number of open Right Medicine gaps (e.g. adherence to prescriptive medicine). In certain embodiments, the chart can identify the number of admissions and provide alerts if the number or percentage of patients identified as “Identified—Not Touched”, “Touched”, “Enrolled”, or “Actively Engaged”, “Disenrolled—Opted Out” or “Disenrolled—Success” decreases by a certain number or percentage. In addition, an alert may be set if the number of high risk care gap patients exceeds a certain threshold.

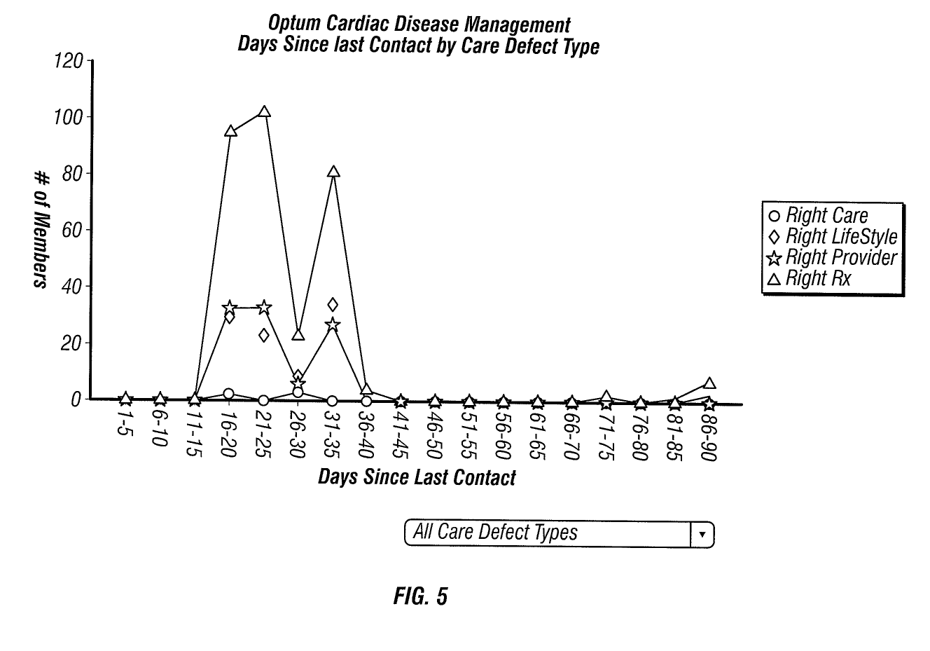

Referring now to FIG. 5, a chart entitled “Days Since Last Contact by Care Defect Type” depicts the operational status for working with members on their areas of concern (care defects) for properly managing their disease. The chart shows the total number of care defects for each care rollup type, broken down by days since last contact. In the embodiment shown, the care defects are broken into “Right Care”, “Right Rx” (e.g. “Right Medicine”), “Right Provider” and “Right Lifestyle”. In certain embodiments, the chart can be updated weekly, but in other embodiments, the chart may be updated at other intervals, including, for example, one minute or less. In specific embodiments, the chart provides the user the ability to filter on a region and market, and/or the ability to show each disease management programs patients via toggle.

In specific embodiments, the chart can display the number of members falling into categories based on the number of days since contact has been made with the member. In a specific embodiment, the categories may be grouped as follows: 1-5 days, 6-10 days, 11-15 days, 16-20 days, 21-25 days, 26-30 days, 31-35 days, 36-40 days, 41-50 days, 51-60 days, 61-70 days, 71-80 days, 81-90 days, and 91+ days. In other embodiments, the categories may be based on different time periods. In certain embodiments, the chart can provide a user the ability to filter for a specific care defect rollup to see gaps in that rollup, and/or the ability to filter on the type of insurance (fully insured, self insured, Medicare, Medicaid, etc.). The user may also be able to examine detailed data to see a list of patients with the corresponding care defect and days since last contact. The detailed data may include the patient's identification number, the patient's name, the disease management nurse, and/or the number of open gaps by gap rollup type.

In certain embodiments, the chart can provide alerts for a cardiac disease management program for a right medicine care defect. In a specific embodiment, the alerts can be based on the number of patients with a care defect (e.g. a level outside of an acceptable range) of Low-density Lipoprotein (LDL) greater than 90 days, with a care defect of hemoglobin A1C greater than 90 days (e.g. missing an A1C lab test for 90 days or more), with a care defect of blood pressure (e.g. above acceptable guidelines) greater than 90 days, with a care defect of any type greater than 30 days.

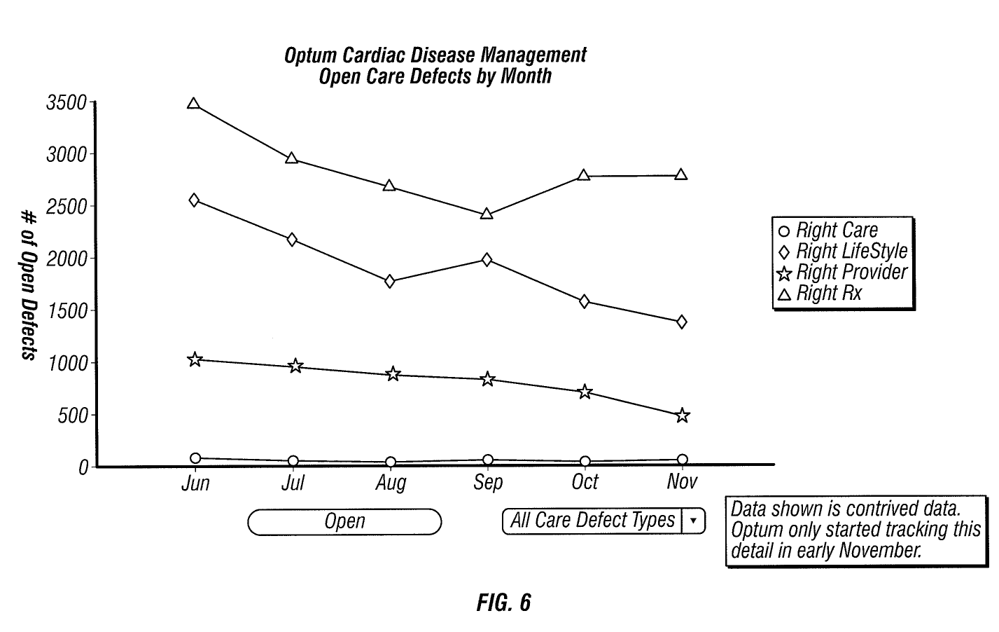

Referring now to FIG. 6, a chart entitled “Opened and Closed Defects by Care Defect Type” shows the total number of care defects in a given month, week, day. This chart provides an operational chart on effectively closing gaps for members to properly manage their disease. In certain embodiments, the chart can be updated weekly, but in other embodiments, the chart may be updated at other intervals, including, for example, one minute or less. In certain embodiments, the chart provides the user the ability to filter on a region and market and to show patients for a specific disease management program, as well as the ability to view by weekly, by month, 3 months, 6 months, 12 months or other intervals.

The user may also be provided the ability to toggle between “Open” and “Closed” gaps, and/or the ability to filter for a specific care defect rollup to see gaps in that rollup. In addition, the chart may allow the user the ability to filter on the type of insurance (fully insured, self insured, Medicare, Medicaid, etc.). The chart may also provide a user with the ability to examine data on an open care defect to see a trend of the average duration of open care defects per month, and/or the ability to review data on a closed care defect to see a trend of the average duration of open care defects closed per month.

In specific embodiments, the chart can illustrate a month-to-month change in the data, and provide alerts if the closed care defects decrease by a certain number or percentage. The chart may also provide alerts based on the number or percentage of open care defects that exceed a certain threshold or the number or percentage of high risk patients with non critical medication compliance.

Referring now to FIG. 7, a chart entitled “Admissions by Day” illustrates the total number of admissions each day in total and by LOS. This data can be used to ensure that member's care is consistent. For example, if a member's treatment or test is completed by Friday morning, the member may be required to stay in the hospital all weekend until the facility is staffed and can perform required tests. Reviewing by day which members are in the hospital by day of week can allow a user to detect patterns that reveal inefficiencies in the utilization of resources. In certain embodiments, the chart may be updated daily, while in other embodiments the chart may be updated based on other time intervals. The chart can provide a user the ability to filter on a region and/or a specific market. The chart may also provide the ability to toggle between facility contract type and facility designation. Specific examples of facility designation include, but are not limited to, “Quality”, “Quality and Efficiency”, “Non-Designated—Par” (e.g., non-designated, but contracted with user's organization), and “Non-Designated—Non-Par” (e.g., non-designated and not contracted with the organization).

The chart may also provide the ability to toggle between all patients and patients enrolled in a corresponding Disease Management program, and/or the ability to view by different time intervals, including for example, 2 week (default), 1 month, 3 month, 6 month, or 12 month. In certain embodiments, the chart may provide the ability to view the total number of admissions, and/or the ability to add and remove contract types and designations. The chart may also provide the ability to toggle between total or percent (for example, a stacked bar) and/or the ability to view slope of a trend line. In specific embodiments, the chart may allow more detailed review of data such as a list of patients that comprise the admissions. The chart can provide metrics such as the percentage of admissions by contract type and designation, as well as the total number of admissions. Alerts may be set if the number of non-par admissions or total admissions increases by a certain number or percentage. Alerts can also be set if there is an increase in the percentage of admissions to specific facilities, including for example, a non-designated facility, and or a facility with a high risk contract for payment.

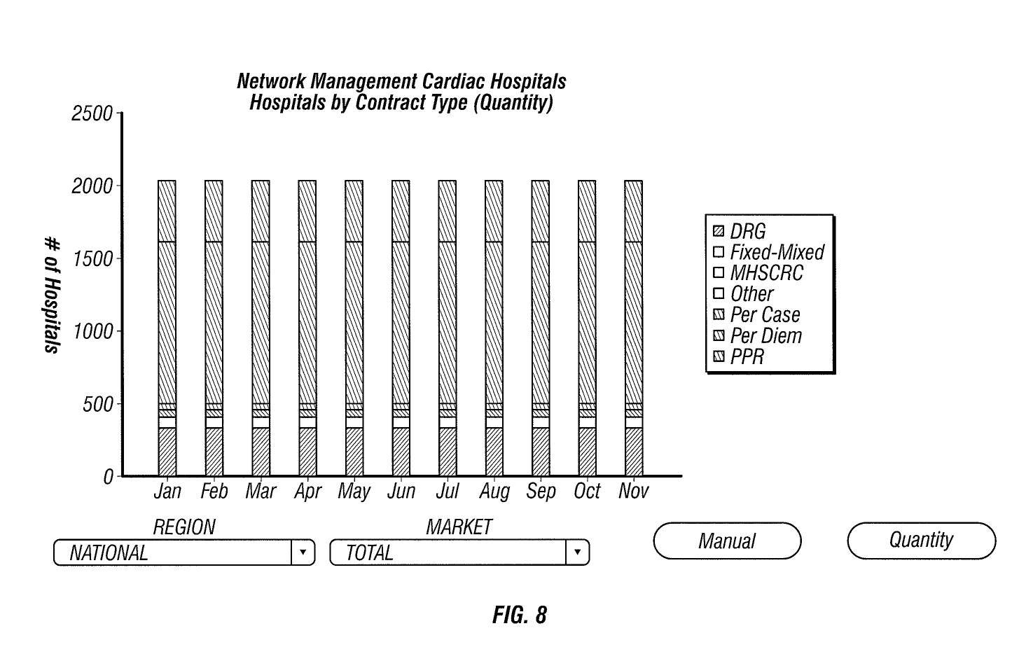

Referring now to FIG. 8, a chart entitled “Hospitals by Contract Type” depicts data on the number of hospitals in a Network Management program broken down by contract type. This chart can allow a user to identify increased utilization by condition by facilities to increase priority and area of focus for contract negotiations. For example, if cardiology is increasing popularity in a facility a user can use this data and not just focus on the overall contract, but potentially special negotiations in the cardiac area specifically. In the specific embodiment shown, the data is displayed in a stacked bar arrangement. The chart may be updated monthly, or any other desired interval. In certain embodiments, the chart allows the user the ability to toggle between displaying data for a rolling twelve months, or for the current month broken down by region and market. The chart may also provide the ability to filter on a region and/or market, and the ability to toggle between quantity and percentage. In certain embodiments, the chart may provide the ability to add and remove contract types, and/or the ability to access the description of each contract type. The chart can also provide the user the ability to review more detailed data, such as reviewing a particular bar to see hospitals of that contract type. In certain embodiments, the chart can provide alerts for a shift in the number or percentage of any contract type. For example if the number or percentage of per diem or DRG (diagnosis related group) facilities in a market decreases by a certain amount, or if the number or percentage of PPR (percentage payment rate) or “Other” facilities increases by a certain amount, an alert may be triggered. In certain embodiments, “per diem” contracts provide an all-inclusive per-day rate for a specific service or bed rate. Other contract types can include “fixed-mix” contracts that provide a fixed rate on most services and a mixed percentage on others.

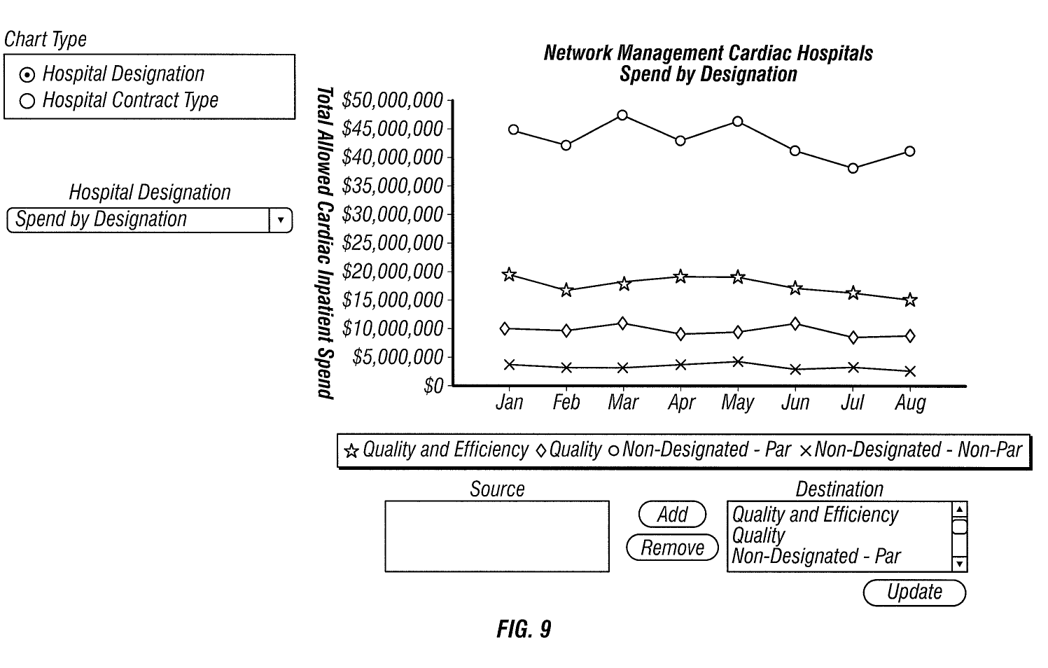

Referring now to FIG. 9, a chart entitled “Spend by Designation” shows a breakdown of facilities by month, based on their number of admissions or their spending. This chart can allow a user to identify increased utilization by condition by facilities to increase priority and area of focus for designation participation for quality and efficiency physicians. This chart can also allow a user to increase efforts for re-directing members to higher quality and higher efficient facilities for their condition. In certain embodiments, the chart can be updated monthly, weekly, daily, or some other suitable interval. The chart may allow the user the ability to filter on region and market, the ability to toggle between spending and admissions, the ability to toggle between quantity and percentage (stacked bar), the ability to toggle between contract type and/or designation, the ability to add and remove contract types or designations. The chart may also allow the user the ability to view by daily, weekly, monthly, 3 months, 6 months, and 12 month intervals. In certain embodiments, the user may be able to view the slope of a trend line, or the ability to view a total.

In specific embodiments, the chart can provide the user the ability to review more detailed data for the most recent month, for example to see the highest-ranking facilities within the corresponding region, market, and contract type/designation, ranked by spending or admissions. Data for such facilities may include the facility name, as well as the MPIN, city, state, contract type, designation (e.g., Quality, Quality & Efficient, Non-Designated, Ineligible, Insufficient due to low volume), number of admissions, total spending and total spending per number of admissions. In certain embodiments, the chart metrics include the percentage of admissions or spending at DRG facilities, PPR facilities, and/or other facilities. In particular embodiments, alerts can be provided if the slope of the line connecting data points (e.g., the rate of change for the data points) is greater than a certain amount.

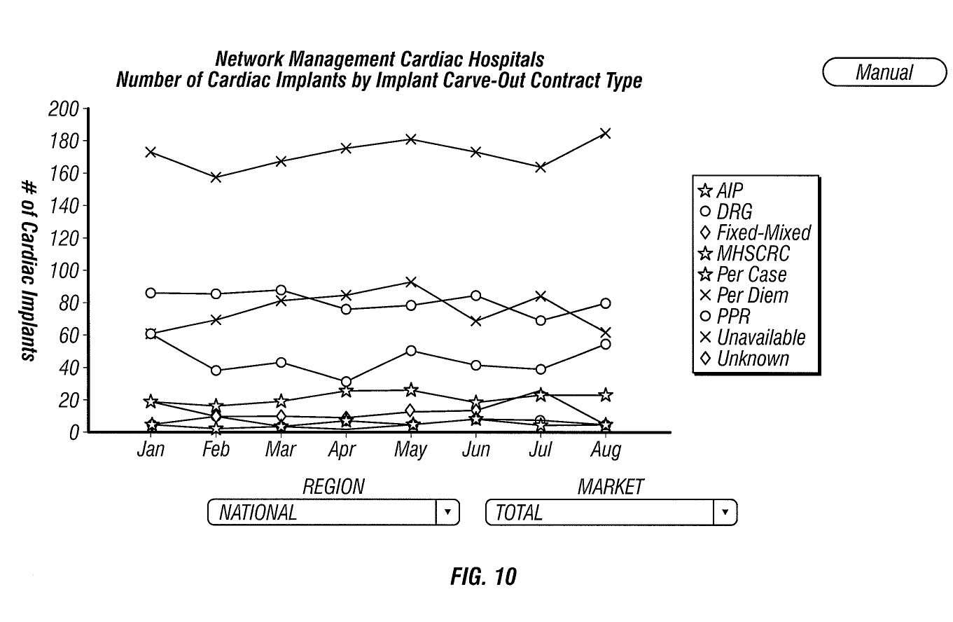

Referring now to FIG. 10, a chart entitled “Number of Cardiac Implants by Implant Carve-Out Contract Type” depicts the total number of LOS applicable implants by implant carve-out contract type, broken down by month. This chart can allow a user to monitor potential abuse for contract carve outs to facilities. In certain embodiments, the chart can be updated monthly, weekly, daily, or any other suitable interval. The chart can allow a user to filter on region and/or market, and toggle between individual contract types and AIP and DRG contracts versus all others (default). In certain embodiments, the chart can provide the ability to toggle between quantity and percentage (for example, in a stacked bar arrangement). The chart may also provide the ability to view by day, week, month, 3 month, 6 month or 12 month intervals. In certain embodiments, the user may be able to review detailed data to see the highest ranking hospitals by volume within a corresponding region, market, and contract type. Data for such facilities may include the facility name, as well as the MPIN, city, state. contract type, designation (e.g., Quality, Quality & Efficient, Non-Designated, Ineligible, Insufficient due to low volume), number of implants, and total spending. Chart metrics include the percentage of AIP/DRG facilities, and alerts may be set if the percentage of AIP/DRG is greater than a specific amount.

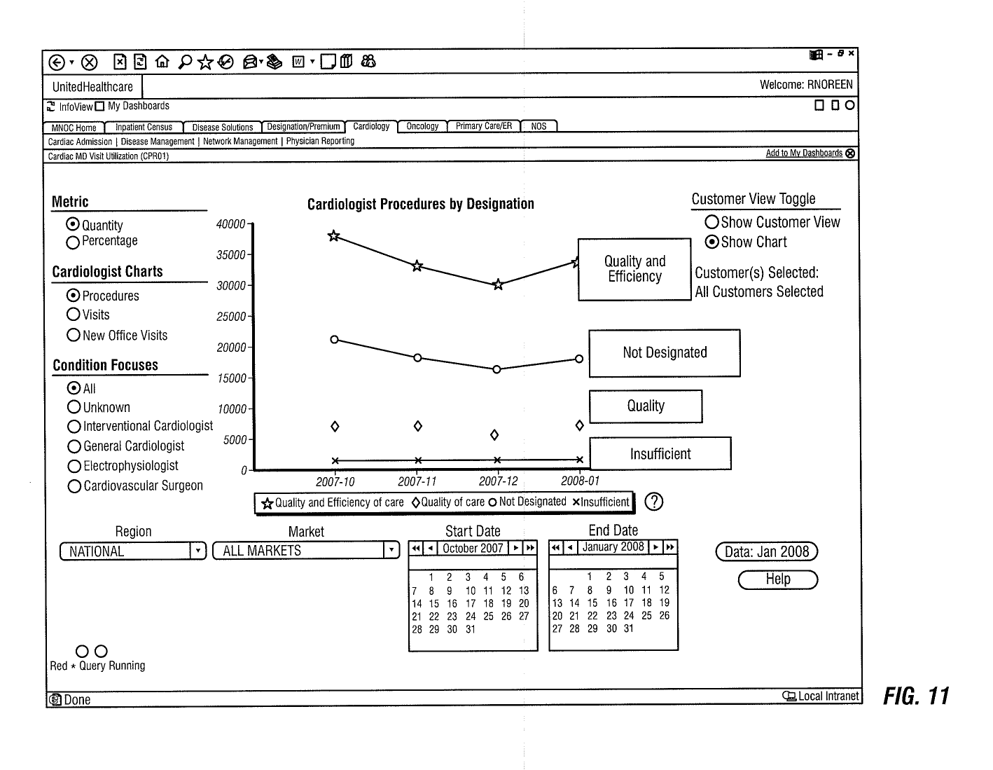

Referring now to FIG. 11, a chart illustrates the total number of LOS specific procedures or office visits per month broken down by provider of care designation. In the particular embodiment shown, the LOS is cardiology. The chart provides a user with the ability to ensure that members are utilizing the best performing physicians. If a shift is detected to increased utilization of lower performing physicians, a user can increase working with the providers to improve care and/or help direct members to quality and efficient physicians. The chart can be updated monthly, weekly, daily, or any other suitable time interval, and may allow a user the ability to filter by region and market and/or by physician condition focus (specialty). In certain embodiments, a user may have the ability to toggle between selected procedures, total office visits, new office visits and consultations. A user may also have the ability to toggle between quantity and percentage (stacked bar), and/or the ability to view by 3 month, 6 month, or 12 month intervals.

The chart can allow a user to quickly detect trends by viewing the slope of a line connecting data points. In specific embodiments, a user may obtain detailed data on physicians with highest procedure utilization by selected area in toggles. Such data may include the physician's name, the number of cases or procedures, the physician MPIN/TIN, the physician's group affiliations (which may be sorted by Data Sharing Group, alphabetical), and the Data Sharing Group (a group selected for utilization improvement through coaching). Alerts can be triggered when the percentage of a particular LOS procedure performed by non-designated physicians and/or the percentage of office visits to non-designated physicians pass a certain threshold.

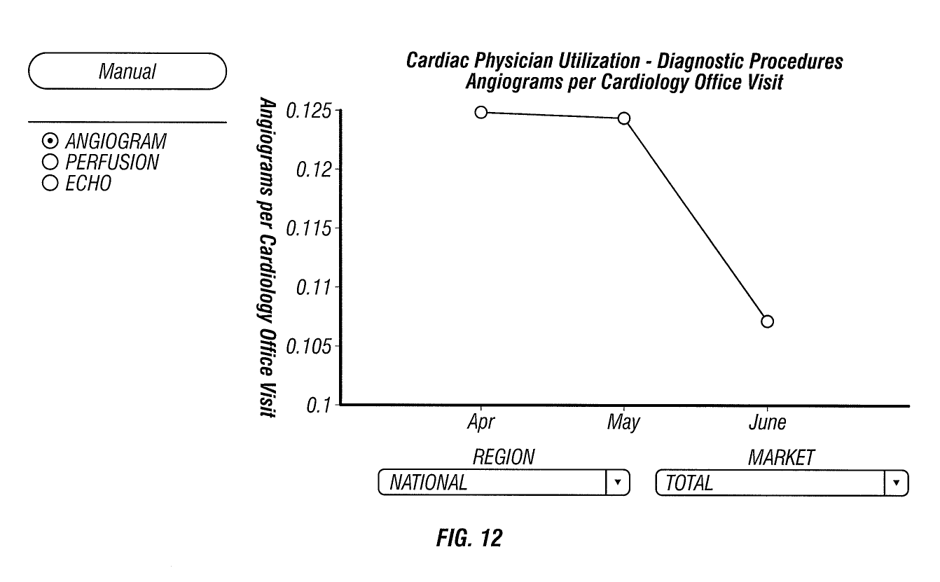

Referring now to FIG. 12, an exemplary chart entitled “Cardiac Physician Utilization—Diagnostic Procedures” depicts LOS specified diagnostic procedures per office visit by month. In certain embodiments, the chart may be updated monthly, weekly, daily or some other suitable interval. This chart presents data similar to that of FIG. 12, but depicts data for utilization rates for a specific procedure (angiograms in the embodiment shown). As used herein, the term “utilization rate” includes the frequency, percentage or ratio at which a health care provider utilizes a specific procedure. In general terms, the utilization rate provides an indication of how often a health care provider utilizes a procedure for a given population of patients. While the utilization rate for angiograms is shown in this exemplary embodiment, other exemplary embodiments may provide data for utilization rates for any other procedure related to an individual's health. Non-limiting examples of such cardiac procedures include perfusion, echocardiogram, EKG, stress test, cardiac CT (computed tomography), and/or cardiac MRI. This list of procedures is intended to provide only a small sample of the broad spectrum of procedures for which utilization rates may be reviewed. Other exemplary displays can provide data for non-cardiac procedures, including but not limited to, procedures related to the diagnosis and/or treatment of conditions such as cancer, diabetes, asthma, chronic obstructive pulmonary disease, and/or back pain. Specific embodiments provide the user the ability to filter on region and market, as well as the ability to toggle between diagnostic procedures selected by each LOS team. In certain embodiments, the chart can provide the ability to view by daily, weekly, monthly, 3 month, 6 month, and 12 month intervals. The chart may also provide the ability to toggle between viewing data by days, weeks, months, or viewing current month data across regions and markets. The chart may also provide the ability to view the slope of a trend line.

In certain embodiments, the chart may allow a user to review detailed data for physicians with the highest metric (subject to minimum volume criteria). Such data may include the physician's name, the number of cases or procedures, the physician MPIN/TIN, group affiliations (if more then one, the groups may be alphabetically sorted by data sharing group), and data sharing group (Boolean), which allows a group to be selected for utilization improvement through coaching. In specific embodiments, the chart metrics may include the ratio of procedures to office visits, and alerts may be provided based on an increase in the number or percentage of angiograms, perfusions, echocardiograms, EKGs, stress tests, cardiac CTs (computed tomography), and/or cardiac MRIs per visit.

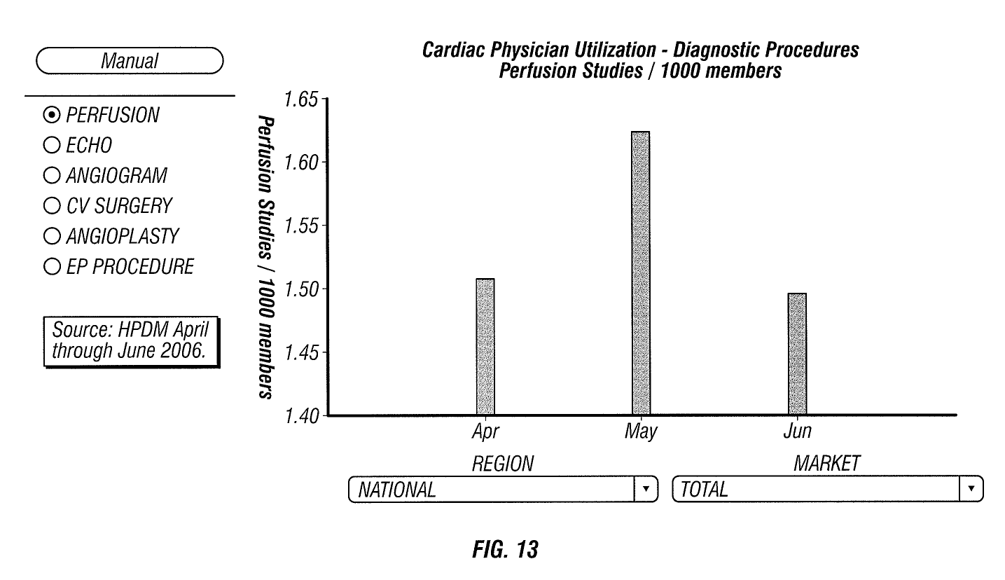

Referring now to FIG. 13, a chart provides data similar to that shown in FIG. 12. In the embodiment shown in FIG. 13, however, the chart provides data for the number of LOS procedures per 1,000 members. The chart can provide data to allow a user to see which providers are utilized and how they rank for quality and efficiency. A user can then either target high utilization physicians to improve physician performance or redirect members. The chart may be updated monthly, weekly, daily or at any other suitable interval. In certain embodiments, the chart can provide the user the ability to filter on a region and market, a condition focus, and/or to toggle between LOS selected procedures. Examples of such procedures include: perfusion, echocardiogram, angiogram, EKG (electrocardiogram), stress test, cardiac CT (computed tomography), cardiac MRI (magnetic resonance imaging), CV (cardiovascular) surgery, angioplasty, and/or EP (electrophysiology) procedure (e.g. ablations or implanting of implanted cardioverter defibrillator or pacemakers). The chart can provide the ability to view by daily, weekly, monthly, 3 month, 6 month and/or 12 month intervals, as well as the ability to toggle between viewing data by day, week, months, or viewing current month data across regions and markets.

In specific embodiments, the chart can provide the ability to view detailed data on any point and view data on physicians with the highest metric (subject to minimum volume criteria). Such data may include the physician's name, the number of cases or procedures, the physician MPIN/TIN, group affiliations (if more then one, the groups may be alphabetically sorted by data sharing group), and data sharing group (Boolean), which allows a group to be selected for utilization improvement through coaching. In the embodiment shown, the chart metric is the ratio of procedures per 1000 members and alerts may be provided if the number of any of the previously-listed procedures per thousand members exceed a certain value.

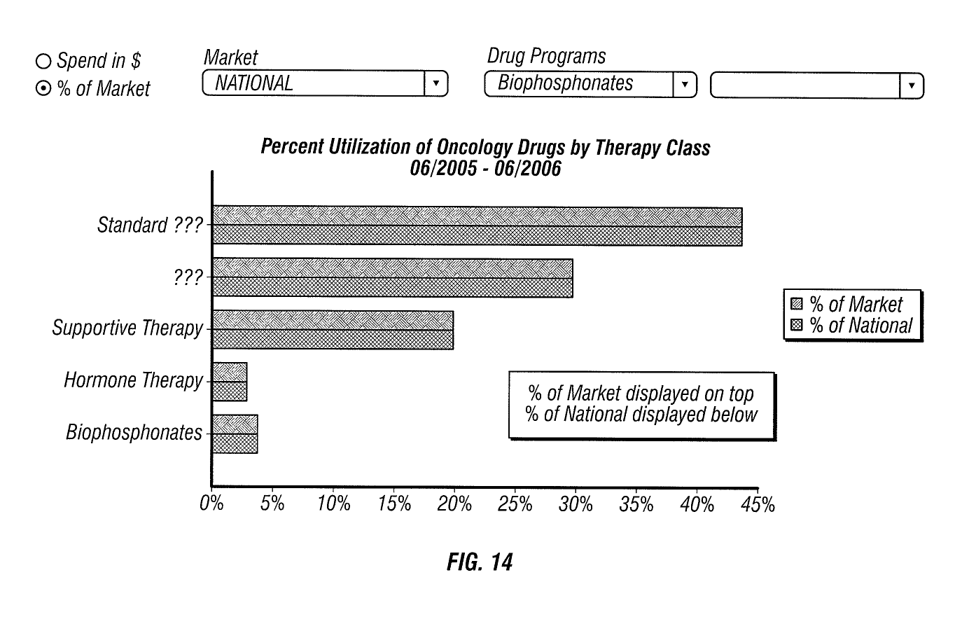

Referring now to FIG. 14, a chart provides data for the percent utilization of drugs by therapy class by LOS based on the amount of money spent per therapy class. The chart can also depict the market versus national utilization of amounts spent per therapy class. In certain embodiments, the chart compares the therapy classes of drug programs, for example oncology: standard chemotherapy, monoclonal/biologic, supportive therapy, hormone therapy, biophosphonates. This chart can allow a user to better understand physician utilization of the drug therapy classes. The chart may be updated monthly, weekly, daily, or any other suitable time interval, and/or may allow a user the ability to filter on a region and market. In specific embodiments, the user may have the ability to toggle between amount spent in dollars and percent utilization, and/or the ability to chart data annually, monthly, weekly or daily. The user may also have the ability to review detailed data for the individual drugs for each drug program. The chart metrics include the measure of dollars spent and alerts can be set if the utilization or amount spend on therapy class exceeds a set threshold.

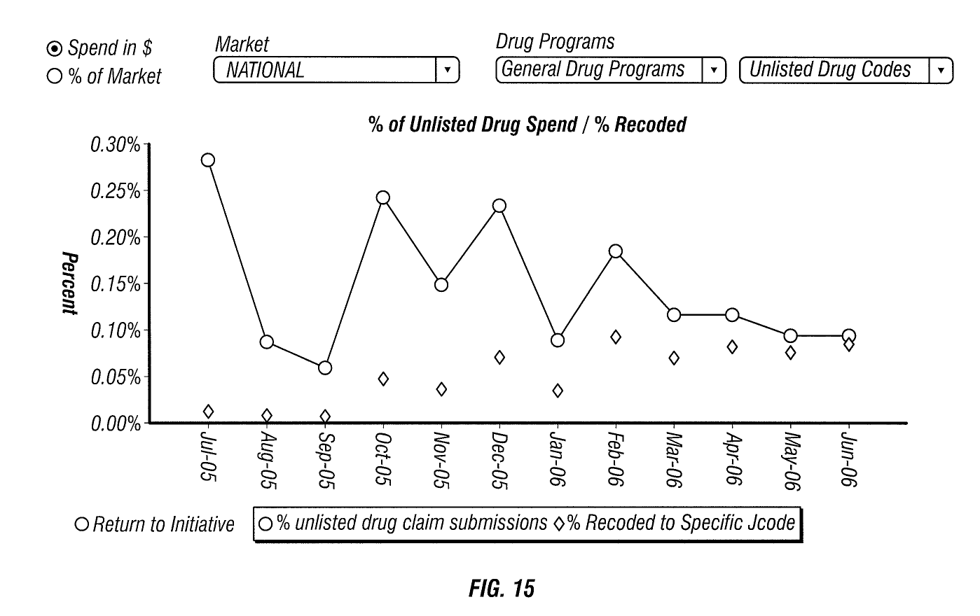

Referring now to FIG. 15, a chart displays data comparing the percentage of drug claims that are unlisted against the percentage of drugs that were recoded to a specific J-Code (product-specific billing code). In certain circumstances, physicians may have financial incentives on how they administer and select drugs. This chart can allow a user to monitor and ensure usual and customary utilization of drug administration and selection. The chart may be updated monthly, weekly, daily, or any other suitable time interval.

The chart shown in FIG. 15 provides more detailed data from that provided in FIG. 14 and, in certain embodiments, allows a user to chart data points on a rolling 12 month schedule, 52 weeks or 365 days. The data can be filtered by region and market and can be backed out to provide the data available in FIG. 14. The chart metrics include the percentage measure of drug claims, and an alarm may be provided when a percentage exceeds a threshold.

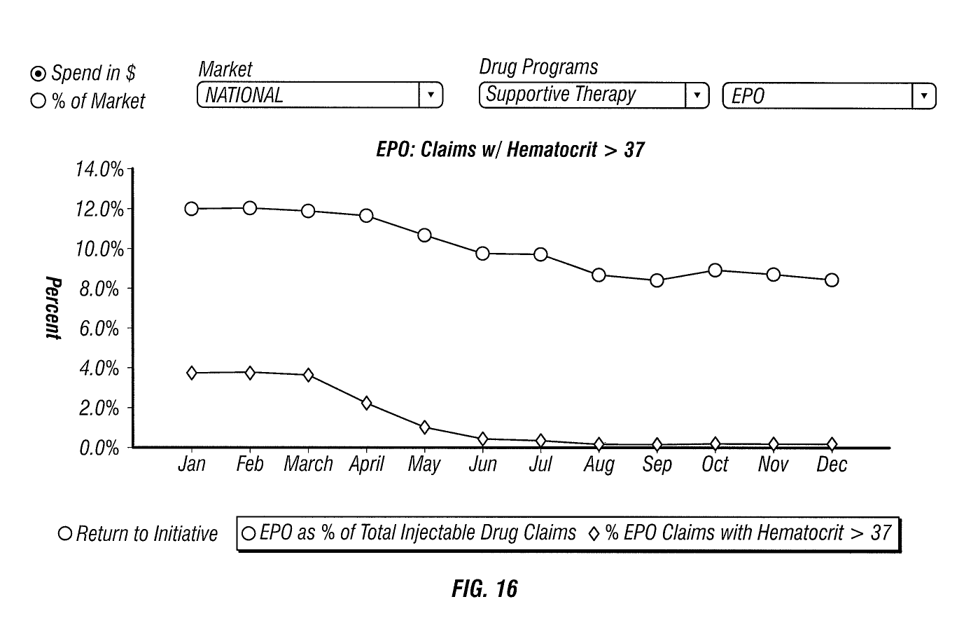

Referring now to FIG. 16, the exemplary chart shown also provides a more detailed look at the data in provided in FIG. 14. The chart shown provides data that can be used to confirm that an administered drug is appropriate for the patient. For example, some drugs are only effective if certain genes are present, or are dangerous if not necessary (e.g., if the patient's red blood cell count is low). Charts such as those shown in FIG. 16 match lab results to administered drugs to ensure the appropriateness of the drug. The embodiment shown in FIG. 16 depicts the overall percentage of injectable drug claims that include EPO, as well as the percentage of EPO claims with a hematocrit level greater than 37 percent. Such data can be used to determine if EPO is being administered in the proper circumstances (e.g., when the hematocrit level is below 37 percent). In specific embodiments, the chart can be updated monthly, weekly, daily, or any other suitable interval. The chart may also provide a user the ability to filter on a region or market, and/or the ability to review data for a specific patient or physician. The chart can provide an alert when the percentage of EPO claims for patients with a hematocrit level greater than 37 percent exceeds a certain threshold.

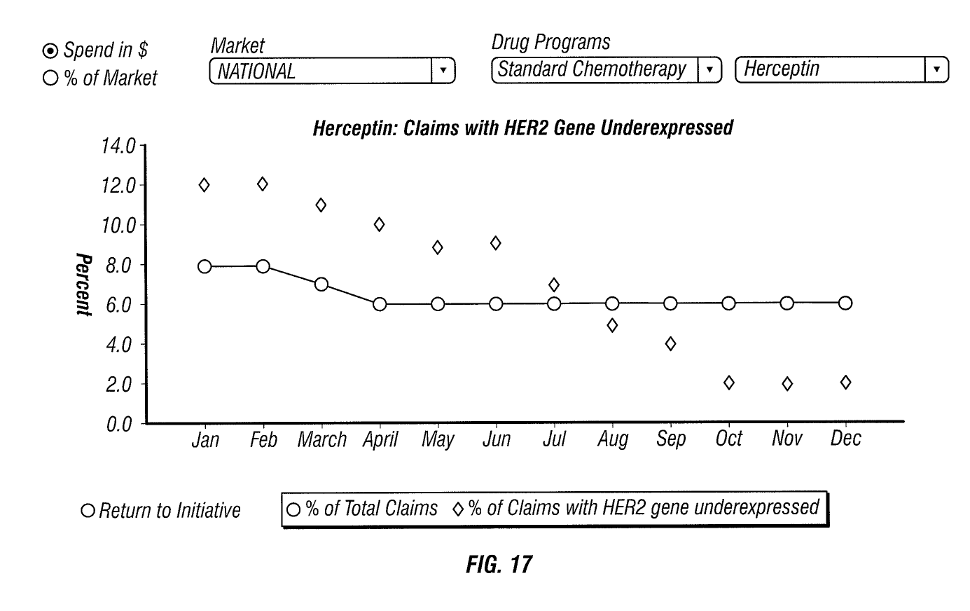

The chart shown in FIG. 17 is similar to FIG. 16 in that it provides data that can allow a user to evaluate if a particular drug is being administered effectively. However, in this example the drug being evaluated is Herceptin, and the patient condition being evaluated is underexpression of the HER2 gene. This chart allows a data to determine the percentage of patients that have the HER2 gene underexpressed that are being administered Herceptin. The HER2 gene must be present for Herceptin to be effective. A user can review this data to ensure that the percentage of patients with the HER2 gene underexpressed that are being administered Herecptin is below a certain threshold. If the threshold is exceeded, an alert may be triggered. Other attributes of the chart in FIG. 17 are equivalent to that of the chart shown in FIG. 16.

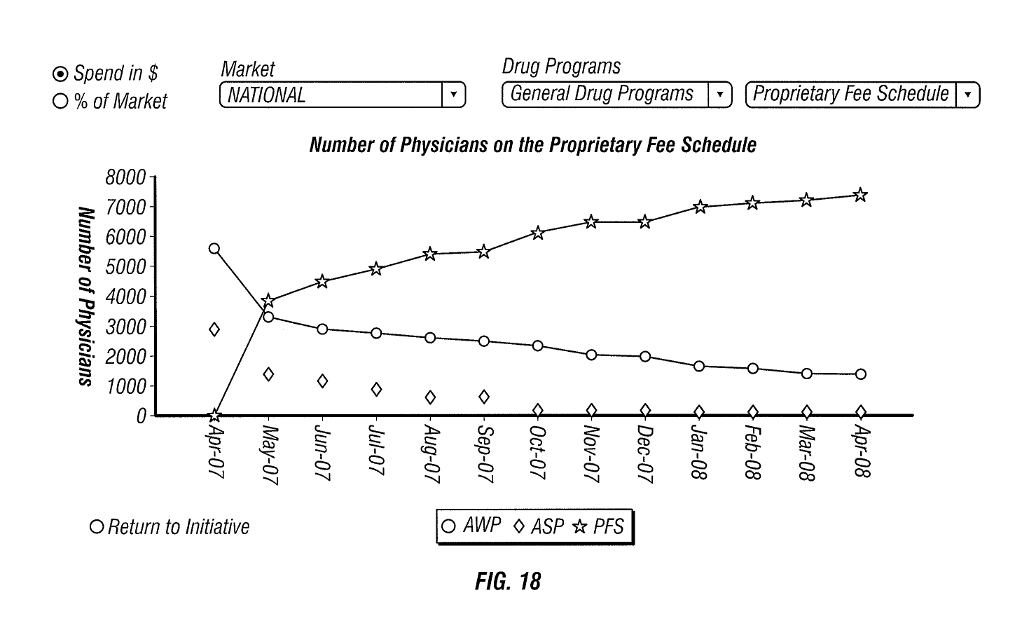

Referring now to FIG. 18, this chart depicts the number of physicians that are on a proprietary fee schedules. The chart shown in FIG. 18 also provides data for the number of physicians that are under the average wholesale price (AWP) or under the average sales price (ASP). The chart can be updated monthly, weekly, daily, or any other desired interval. The chart may also provide the ability to view data on a rolling 12 month, 52 week, or 365 day display, and to filter on a region or market. Alerts may be provided when the number of physicians on the proprietary fee schedule drops below threshold, or when the number of physicians under average wholesale price or average sales price exceeds threshold.

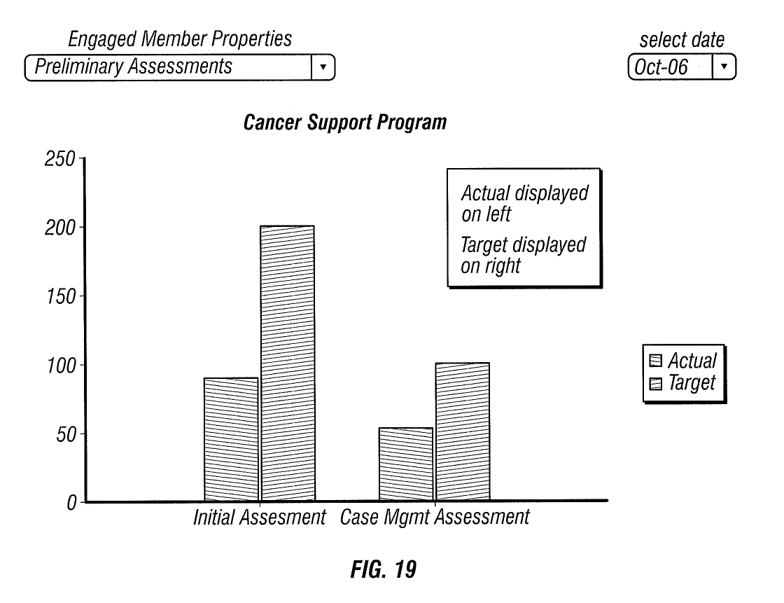

Referring now to FIG. 19, the chart shown provides additional information for the Line of Service (LOS) Disease Management (DM) program (which was also illustrated in FIGS. 3-6). This chart depicts the actual and target numbers for enrolled and engaged members for a Cancer Support Program for a selected month. This chart can be updated monthly, weekly, daily, or at any other suitable interval. The chart can also provide a user the ability to filter by month, week, date, and/or the ability to filter by region and market. The chart can provide alerts if the number of enrolled and/or engaged members falls outside an accepted range.

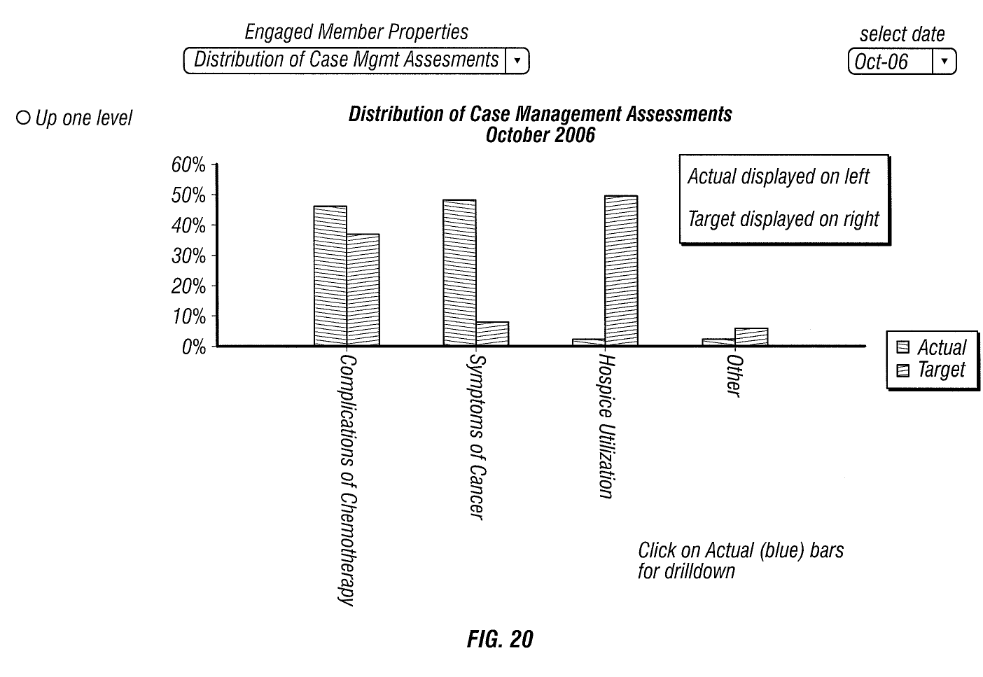

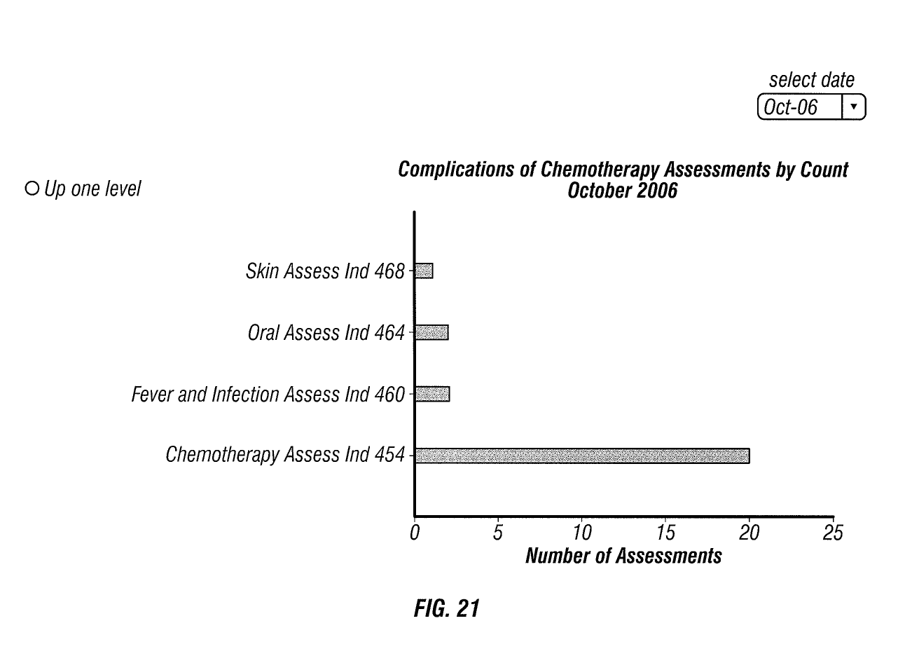

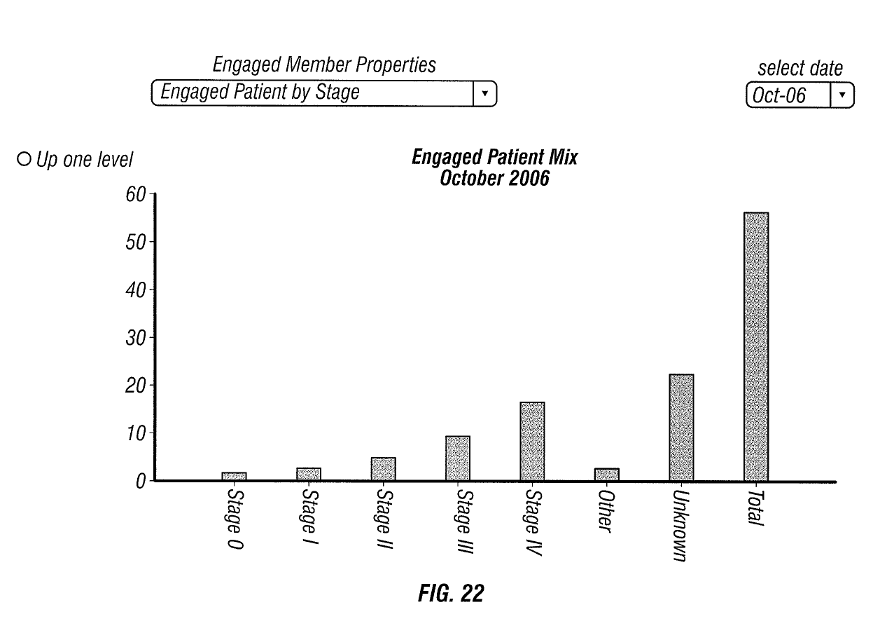

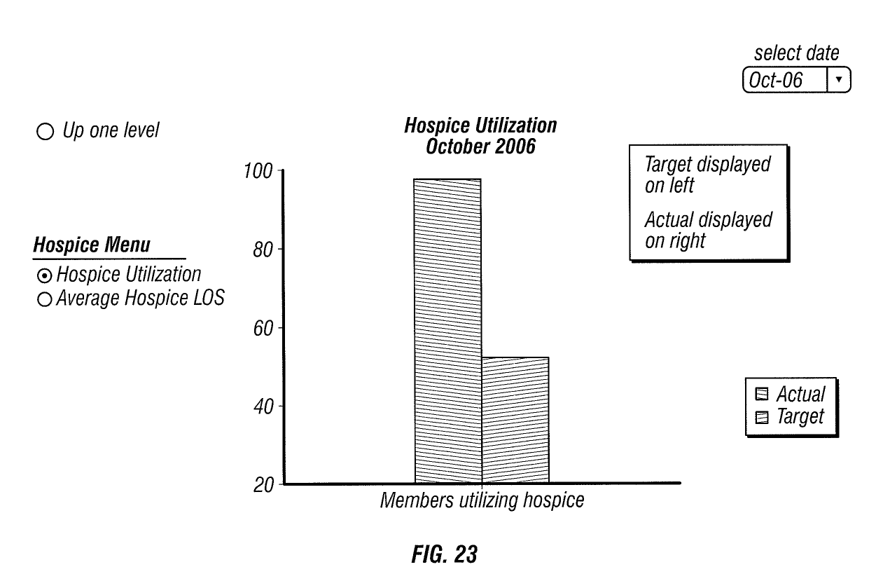

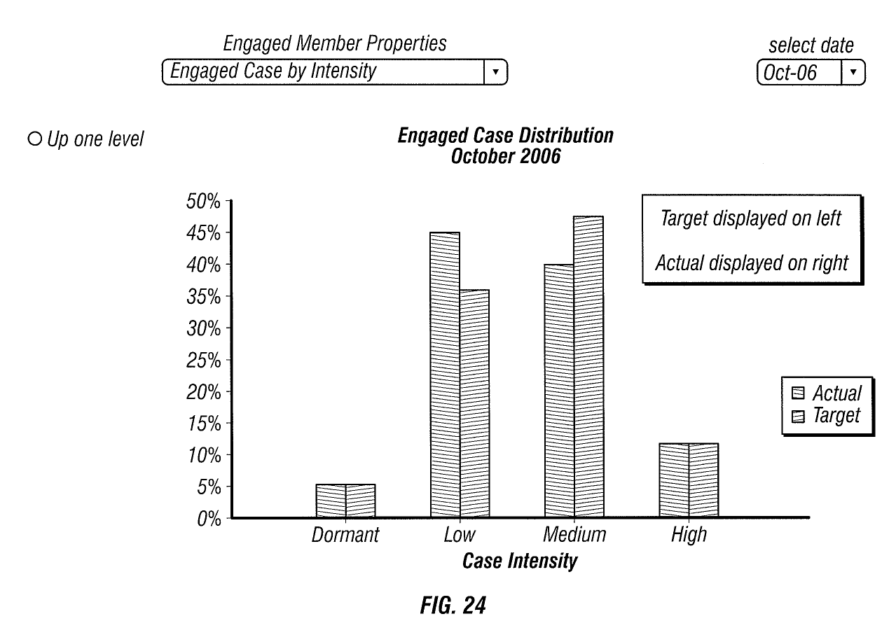

The chart illustrated in FIG. 20 depicts the distribution of Case Management Assessments by assessment category for the Cancer Support Program. The embodiment shown illustrates categories including “Complications of Chemotherapy”, “Symptoms of Cancer”, “Hospice Utilization”, and “Other”. This chart can be updated monthly, weekly, daily, or at any other suitable interval. In certain embodiments, the user has the ability to chart the actual values with a target value parameter, the ability to filter by region and market, and/or the ability to toggle to the data shown in FIG. 22 and FIG. 24. A user may also be able to back out of the chart shown in FIG. 20 to view the data shown in FIG. 19, as well as examine more detailed data in the assessment categories to see a distribution of standard assessments within each category (FIG. 21). A user may also be able to examine more detailed data, such as a hospice utilization assessment to view the number of patients utilizing hospice and average hospice length of stay (e.g. as shown in FIG. 23). The chart may also provide alerts of the percentages of any category fall outside an accepted range.

Referring now to FIG. 21, the chart depicts the total number of assessments in the assessment category selected from FIG. 20. This chart can allow a user to monitor disease management operational targets and ensure programs are performing to standard for reaching out to members. This chart can be updated monthly, weekly, daily, or at any other suitable interval, and can be filtered by region and market. The chart can provide an alert if the total number of assessments exceeds a threshold.

Referring now to FIG. 22 the chart provides data relating to the cancer stage of engaged patients for a given program. This chart can be updated monthly, weekly, daily, or at any other suitable interval, and can be filtered by month, week, date, region and/or market. A user can toggle between the data in this chart and the data in FIGS. 20 and 24. The chart can provide alerts if the patients in any stage exceed a certain threshold.

FIG. 23 provides a chart that provides a more detailed view of the data provided in FIG. 20. In this specific embodiment, the chart depicts the actual and target number of members utilizing hospice, and their average length of stay by contract type. This chart can be updated monthly, weekly, daily, or at any other suitable interval, and can be filtered by month, week, date, region and/or market. The user may toggle between hospice utilization and average hospice length of stay and may also toggle by contract type. The user may also be able to move between overall numbers and data for the patient level. An alert may be provided if the number of members utilizing hospice exceeds a threshold.

Referring now to FIG. 24, provides more detailed data based on that provided in FIG. 20. In this embodiments, the chart depicts the actual and target percentage of patients in dormant, low, medium and high case intensities for the month. This chart can be updated monthly, weekly, daily, or at any other suitable interval, and can be filtered by month, week, date, region and/or market. In specific embodiments, a user may toggle to data provided in FIGS. 20 and 22, and may view data down to patient level. Alerts may be set of the percentage of dormant, low, medium or high case intensities fall outside an accepted range.

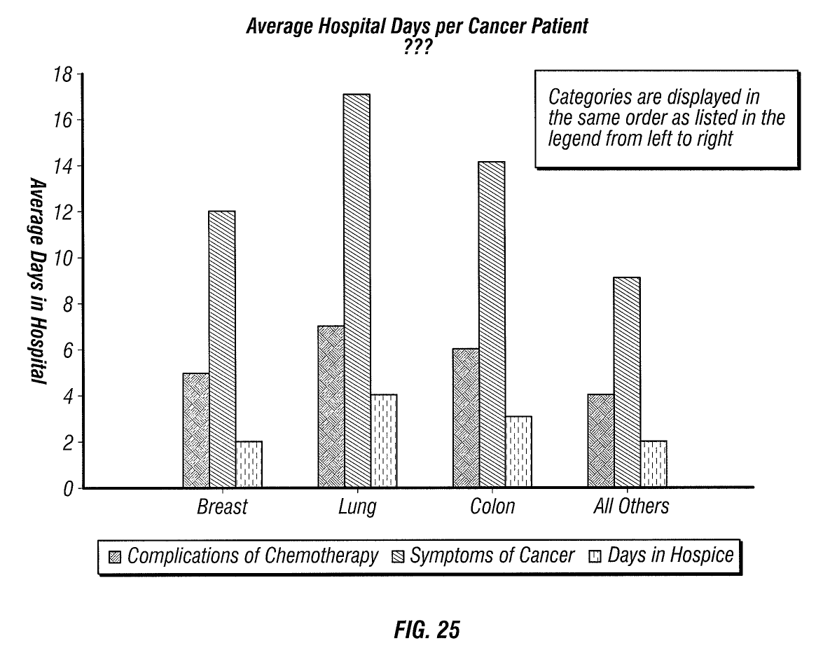

FIG. 25 provides data similar to that shown in FIG. 2, but illustrates data for a different LOS (cancer, rather than cardiac). This chart depicts the average number of days in the hospital for patients by condition. For example, the chart provides data for patients in the Cancer LOS and includes breast, lung, colon and other forms of cancer broken down by complications of chemotherapy, symptoms of cancer, and days in hospice. Other attributes of FIG. 25 are equivalent to those provided for FIG. 2.

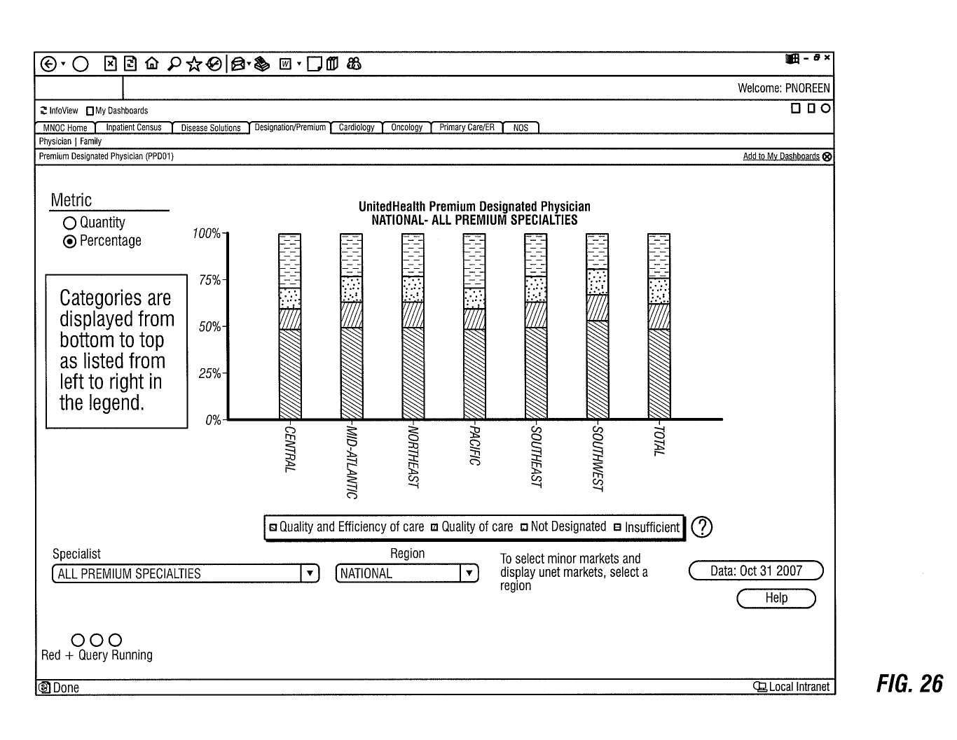

Referring now to FIG. 26, the chart shows the total number or percentage of physicians by designation status for each specialty (individually or in total) by region/market. In this embodiment, four physician designations are provided: “Quality and Efficiency of Care”, “Quality of Care”, “Not Designated”, and “Insufficient”. Embodiments may also include a designation of “Not Eligible”. This data assists a user in evaluating if a physician is providing quality and efficient care, and can be leveraged to steer members to providers that provide the best care for their condition. This chart can be updated monthly, weekly, daily, or at any other suitable interval. The user may have the ability to filter on a region, market or zip code, and may have the ability to toggle between percentage and quantity, between all specialties, all designate-able specialties, or individual specialties. A user may have the ability to view data on any region and/or to view designation status or by specialty for each market in the region.

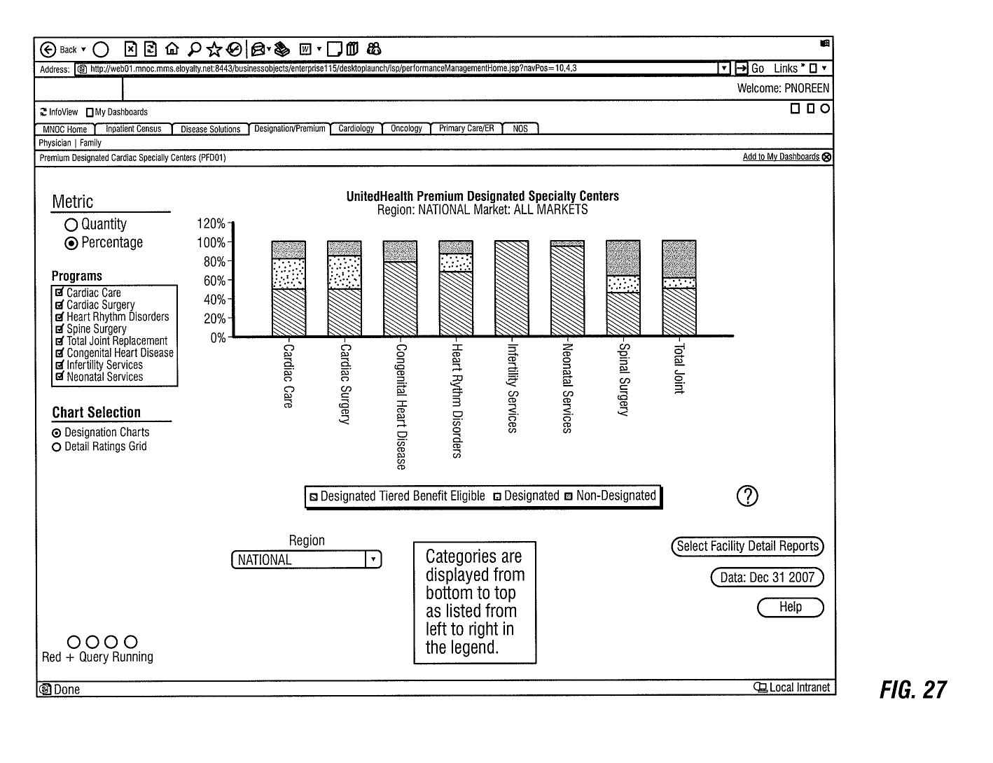

Referring now to FIG. 27, a chart shows the total number or percentage of designated facilities by each region/market. This data assists a user in determining if a specialty center (e.g., a cardiac center for heart failure or coronary artery disease) is providing quality and efficient service (e.g., evidence-based medicine protocols followed, and higher than average outcomes for conditions). The centers can be categorized as “Designated—Tiered Benefit Eligible”, “Designated”, or “Non-Designated”.

This shows which providers are designated. This is leveraged to steer members to providers that provide the best care for their condition. This chart can be updated monthly, weekly, daily, or at any other suitable interval. The user may have the ability to filter on a region, market or zip code, and may have the ability to toggle between percentage and quantity. In certain embodiments, the user may have the ability to drilldown on a region to view designation status for a market, as well as have the ability to drilldown on any market to view a list of facilities with a specific designation status.

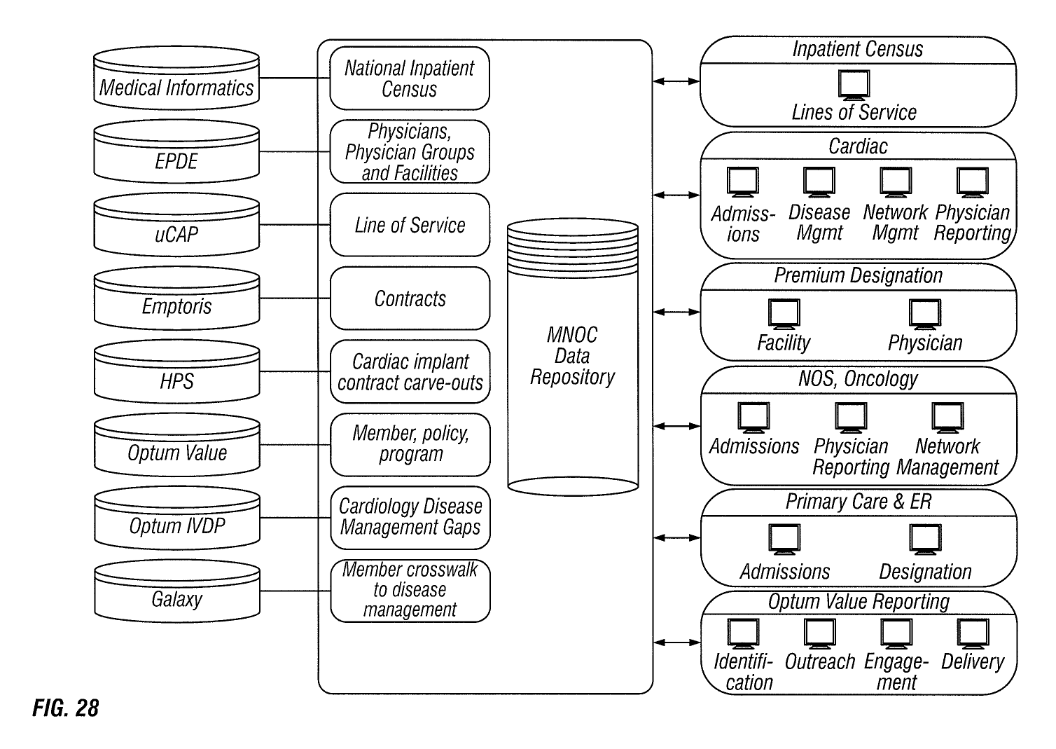

Turning now to FIG. 28, a MNOC system architecture is depicted. In one embodiment, the MNOC system may have a two-tiered server architecture consisting of one database server and one application server. Users may be grouped into pre-defined profiles which determine the level of drilldown data available as well as which charts will be exposed. Granting user access may be determined by the MNOC operations manager. Preferably, the MNOC system may render 80% of the charts in an average time of 3-4 seconds with a maximum limit of 10 seconds. The remaining 20% of the charts may be rendered in an average time of 10 seconds with a maximum limit of 30 seconds. Special consideration may be given to specific charts where complex queries may affect performance in excess of the aforementioned metrics.

The functions and/or algorithms described above may be implemented, for example, in software or as a combination of software and human implemented procedures. Software may comprise computer executable instructions stored on computer readable media such as memory or other type of storage devices. Further, functions may correspond to modules, which may be software, hardware, firmware or any combination thereof. Multiple functions may be performed in one or more modules as desired, and the embodiments described are merely examples. Software may be executed on a digital signal processor, ASIC, microprocessor, or other type of processor operating on a computer system, such as a personal computer, server or any other computer system.

The software, computer program logic, or code segments implementing various embodiments of the present invention may be stored in a computer readable medium of a computer program product. The term “computer readable medium” includes any medium that can store or transfer information. Examples of the computer program products include an electronic circuit, a semiconductor memory device, a ROM, a flash memory, an erasable ROM (EROM), a floppy diskette, a compact disk CD-ROM, an optical disk, a hard disk, and the like. Code segments may be downloaded via computer networks such as the Internet or the like.

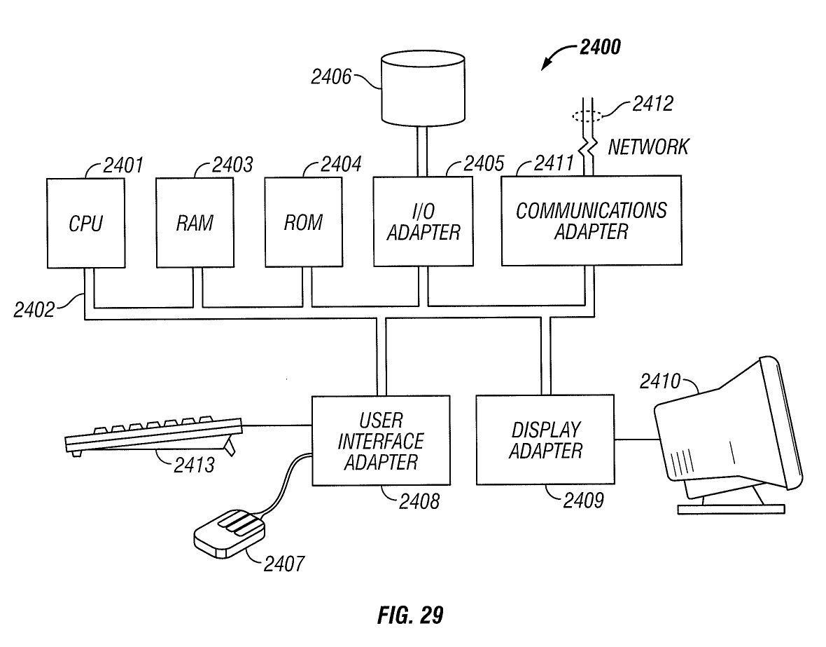

FIG. 29 illustrates computer system 2400 adapted to use embodiments of the present invention (e.g., storing and/or executing software associated with the embodiments). Central processing unit (“CPU”) 2401 is coupled to system bus 2402. CPU 2401 may be any general purpose CPU. However, embodiments of the present invention are not restricted by the architecture of CPU 2401 as long as CPU 2401 supports the inventive operations as described herein. Bus 2402 is coupled to random access memory (“RAM”) 2403, which may be SRAM, DRAM, or SDRAM. ROM 2404 is also coupled to bus 2402, which may be PROM, EPROM, or EEPROM.

Bus 2402 is also coupled to input/output (“I/O”) controller card 2405, communications adapter card 2411, user interface card 2408, and display card 2409. I/O adapter card 2405 connects storage devices 2406, such as one or more of a hard drive, a CD drive, a floppy disk drive, a tape drive, to computer system 2400. I/O adapter 2405 is also connected to a printer (not shown), which would allow the system to print paper copies of information such as documents, photographs, articles, and the like. Note that the printer may be a printer (e.g., dot matrix, laser, and the like), a fax machine, scanner, or a copier machine. Communications card 2411 is adapted to couple the computer system 2400 to network 2412, which may be one or more of a telephone network, a local (“LAN”) and/or a wide-area (“WAN”) network, an Ethernet network, and/or the Internet. User interface card 2408 couples user input devices, such as keyboard 2413, pointing device 2407, and the like, to computer system 2400. Display card 2409 is driven by CPU 2401 to control the display on display device 2410.

Although certain embodiments of the present invention and their advantages have been described herein in detail, it should be understood that various changes, substitutions and alterations can be made without departing from the spirit and scope of the invention as defined by the appended claims. Moreover, the scope of the present invention is not intended to be limited to the particular embodiments of the processes, machines, manufactures, means, methods, and steps described herein. As a person of ordinary skill in the art will readily appreciate from this disclosure, other processes, machines, manufactures, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufactures, means, methods, or steps.

### Glossary of Terms

MNOC—Medical National Operations Center
CIN—Clinically Integrated Network
LOS—Line of Service
TAM—Total Affordability Management
NOS—Neurology, Orthopedics, and Spinal
HPDM—Health Plan Data Mart—source for claims data
COM—Clinical Operations Mart
CCF-CCS—Care Coordination System—Common Clinical Framework—source for Optum inpatient data
DDB—Premium Designation Database—source for premium designation data
CID—Contract Information Database—source for contract information
HCTA—Health Care Trend Analysis—source for membership data
HPS—Hospital Purchasing Solutions—group for implant carve-out contracts
MMD—Market Medical Director
DRG—diagnosis related group
PPR—percentage payment rate

1. A method of identifying and contacting a candidate for a disease management program, the method comprising:
reviewing data for admissions to a health care facility for a plurality of health care plan members;
identifying a condition for the admissions of the plurality of health care plan members;
identifying a disease management program addressing the condition;
reviewing an enrollment status in the disease management program for the plurality of health care plan members;
identifying a non-enrolled portion of the plurality of health care plan members that are not engaged in the disease management program;
contacting a member the non-enrolled portion while the member of the non-enrolled portion is admitted to the health care facility or shortly thereafter; and
requesting that the member of the non-enrolled portion become engaged with the disease management program.

2. The method of claim 1, wherein the data for admissions to a health care facility for a plurality of health care plan members is displayed on a graphical user interface.

3. The method of claim 2, wherein the graphical user interface can be manipulated to display data relating to an individual health care plan member.

4. The method of claim 2, wherein the graphical user interface can be manipulated to display data relating to a particular geographic region.

5. The method of claim 2, wherein the graphical user interface can be manipulated to display data based on the type of contractual agreements between the health care facility and a manager of the health care plan.

6. The method of claim 2, wherein the graphical user interface can be manipulated to display data relating to an individual physician.

7. The method of claim 1, further comprising categorizing the plurality of health care plan members into groups based on the amount of time since the health care plan member has been contacted regarding the disease management program.

8. The method of claim 1, further comprising categorizing the plurality of health care plan members into groups based on the amount of time that the health care plan member has been admitted to the health care facility.

9. The method of claim 1, wherein the condition is selected from the group consisting of: a cardiac condition, asthma, diabetes, an oncological condition, or a neo-natal condition.

10. The method of claim 1, wherein the enrollment status comprises members who have been identified but not contacted regarding the disease management program, members who have been contacted regarding the disease management program, members who are enrolled in the disease management program, members who are actively engaged in the disease management program, and members who are disenrolled in the disease management program.

11. A computer readable medium comprising a computer program recorded thereon that causes a computer to perform the steps of:
providing a graphical user interface;
displaying data for admissions to a health care facility for a plurality of health care plan members;
identifying a condition for the admissions of the plurality of health care plan members;
identifying a disease management program addressing the condition;
displaying an enrollment status in the disease management program for the plurality of health care plan members; and
identifying a non-enrolled portion of the plurality of health care plan members that are not engaged in the disease management program.

12. The computer readable medium of claim 11, wherein the graphical user interface can be manipulated to display data relating to an individual health care plan member.

13. The computer readable medium of claim 11, wherein the graphical user interface can be manipulated to display data relating to a particular geographic region.

14. The computer readable medium of claim 11, wherein the graphical user interface can be manipulated to display data based on the type of contractual agreements between the health care facility and a manager of the health care plan.

15. The computer readable medium of claim 11, wherein the graphical user interface can be manipulated to display data relating to an individual physician.

16. The computer readable medium of claim 11, wherein the graphical user interface is configured to categorize the plurality of health care plan members into groups based on the amount of time since the health care plan member has been contacted regarding the disease management program.

17. A method of evaluating data for utilization rates for health care providers, the method comprising:
obtaining data for utilization rates for a plurality of health care providers;
determining a normal range of utilization;
identifying a subset of the health care providers with utilization rates that are within the normal range of utilization; and
identifying a subset of the health care providers with utilization rates that are outside of the normal range of utilization.

18. The method of claim 17, further comprising:
contacting a health care provider that is in the subset of the health care providers with utilization rates that are outside of the normal range of utilization; and
notifying the health care provider of the normal range of utilization and the utilization rate for the health care provider.

19. The method of claim 17, further comprising:
directing members of a health care plan to receive treatment from health care providers that are within the subset of the health care provider with utilization rates that are within the normal range of utilization.

20. The method of claim 17, wherein the utilization rate comprises a ratio of a cardiac procedure per number of office visits.

21. The method of claim 20, wherein the utilization cardiac procedure is chosen from the list consisting of: an angiogram, a perfusion, an echocardiogram, an EKG, a stress test, a cardiac computed tomography, and a cardiac magnetic resonance imaging.

22. The method of claim 17, further comprising categorizing the data for utilization rates for a plurality of health care providers by geographic region.

23. The method of claim 17, further comprising categorizing the data for utilization rates for a plurality of health care providers by the quality and efficiency of the health care provider.

24. A computer readable medium comprising a computer program recorded thereon that causes a computer to perform the steps of:
providing a graphical user interface;
displaying data for utilization rates for a procedure for a plurality of health care providers;
displaying a normal range of utilization; and
identifying a subset of the health care providers with utilization rates that are outside of the normal range of utilization.

25. The computer readable medium of claim 24, wherein the utilization rates are categorized based on the quality and efficiency of the health care provider.

26. The method of claim 24, wherein the utilization rate comprises a ratio of a cardiac procedure per number of office visits.

27. The method of claim 26, wherein the cardiac procedure is chosen from the list consisting of: an angiogram, a perfusion, an echocardiogram, an EKG, a stress test, a cardiac computed tomography, and a cardiac magnetic resonance imaging.

28. The computer readable medium of claim 24, wherein the graphical user interface can be manipulated to display data for utilization rates for a plurality of health care providers categorized by geographic region.

29. The method of claim 24, wherein the graphical user interface can be manipulated to display data for utilization rates for a plurality of health care providers categorized by the quality and efficiency of the health care provider.

30. A method of identifying an opportunity for an improvement in a health care plan member's quality of health coupled with a medical cost reduction, the method comprising:
reviewing real-time data for admissions to a health care facility for a plurality of members of a health care plan of a client;
identifying a subset of the plurality of members of the health care plan, wherein members of the subset were admitted to the health care facility with one or more conditions;
identifying a disease management program addressing the one or more conditions, wherein the disease management program is not currently purchased by the client;
notifying the client of the subset of the plurality of members of the health care plan that were admitted to the health care facility with the one or more conditions; and
notifying the client of availability of the disease management program.

31. The method of claim 30, wherein the disease management program is configured to address a condition selected from the group consisting of: coronary artery disease, heart failure, diabetes, asthma, chronic obstructive pulmonary disease, and low back pain.
